(19) United States
(12) Patent Application Publication
(10) Pub. No.: US 2026/0313146 A1
(43) Pub. Date: Oct. 8, 2026

(54) METHOD, APPARATUS AND SYSTEM FOR DECODING TENSORS FOR CONTENT OF A BITSTREAM

(71) Applicant: CANON KABUSHIKI KAISHA, Tokyo (JP)

(72) Inventor: Christopher James ROSEWARNE, Concord (AU)

(21) Appl. No.: 19/481,718

(22) PCT Filed: Feb. 7, 2024
(86) PCT No.: PCT/AU2024/050075

§ 371 Date: Nov. 5, 2025

(30) Foreign Application Priority Data
May 19, 2023 (AU) 2023203165

(51) Int. Cl. H04N 19/42; G06N 3/0464; H04N 19/44; H04N 19/70

(52) U.S. Cl. CPC H04N 19/42; G06N 3/0464; H04N 19/44; H04N 19/70

(57) ABSTRACT

A method of decoding tensors for content of a bitstream. The method comprises determining a network topology from the bitstream. A first information is decoded from the bitstream; Decoded tensors are produced from the first information using the determined network topology.

### REFERENCE TO RELATED PATENT APPLICATION

This application claims the benefit under 35 U.S.C. § 119 of the filing date of Australian Patent Application No. 2023203165, filed 19 May 2023, hereby incorporated by reference in its entirety as if fully set forth herein.

### TECHNICAL FIELD

The present invention relates generally to digital video signal processing and, in particular, to a method, apparatus and system for encoding and decoding tensors from a convolutional neural network. The present invention also relates to a computer program product including a computer readable medium having recorded thereon a computer program for encoding and decoding tensors from a convolutional neural network using video compression technology.

### BACKGROUND

Convolutional neural networks (CNNs) are an emerging technology addressing, among other things, use cases involving machine vision such as object detection, instance segmentation, object tracking, human pose estimation, and action recognition. Applications for CNNs can involve use of ‘edge devices’, with sensors and some processing capability, coupled to application servers as part of a ‘cloud’. CNNs can require relatively high computational complexity, more than can typically be afforded either in computing capacity or power consumption by an edge device. Executing a CNN in a distributed manner has emerged as one solution to running leading-edge networks using limited capability edge devices without requiring all computational complexity to be incurred within cloud servers whilst edge devices have potentially under-utilised inferencing resources. In other words, distributed processing allows legacy edge devices to still provide the capability of leading-edge CNNs by distributing processing between the edge device and other processing means, such as cloud servers. Such a distributed network architecture may be referred to as ‘collaborative intelligence’ (CI) and offers benefits such as re-using a partial result from a first portion of the network with several different second portions, perhaps with each portion being optimised for a different task. CI architectures introduce a need for efficient compression of tensor data, for transmission over a network such as a WAN.

CNNs typically include many layers, such as convolution layers and fully connected layers, with data passing from one layer to the next in the form of ‘tensors’. Splitting a network across different devices introduces a need to compress the intermediate multi-dimensional tensor data that passes from one layer to the next within a CNN in order to facilitate transmission over a network having bandwidth limitations or costs. Compression of such tensors may be referred to as ‘feature compression’ and the intermediate tensor data is often referred to as ‘features’ or ‘feature maps’. Features or feature maps are generally a collection of two-dimensional (2D) arrays of values which, when combined into a 3D (or 4D) data structure form a tensor, with each feature map corresponding to one ‘channel’ of the tensor. Intermediate tensor data represents a partially processed form of input such as an image frame or video frame, encountered within a neural network. International Organisation for Standardisation/International Electrotechnical Commission Joint Technical Committee 1/Subcommittee 29/Working Groups 2 (ISO/IEC JTC1/SC29/WG2), also known as the “Moving Picture Experts Group” (MPEG) Technical Requirements are tasked with studying requirements for compression technology in various contexts and often in relation to video. WG2 ‘MPEG Technical Requirements’ has established a ‘Feature Compression for Video Coding for Machines’ (FCVCM) ad-hoc group, mandated to study feature compression. The FCVCM AHG has issued a ‘Call for Proposals’ soliciting responses to form the basis for a standardisation project on feature compression. Previously, responses to a ‘Call for Evidence’ (CfE) demonstrated technology that can significantly outperform feature compression results achieved using state-of-the-art standardised technology directly applied to the tensors.

CNNs typically require weights for each of the layers to be predetermined in a training stage, where a very large amount of training data is passed through the CNN and a result determined by the network undergoing training being compared to ground truth associated with the training data. Discrepancy between the obtained and desired result is expressed as a ‘loss’ and measured with a ‘loss function’. Using the determined loss, a process for updating network weights, such as stochastic gradient descent (SGD), is performed. Network weight update typically involves a process of back-propagation of ‘gradients’ that begins at the output layer of the network and proceeds backward to terminate when the input layer to the network is updated, covering intermediate, or ‘hidden’, layers of the network. Gradients are indicative of deltas to be applied to network weights and are themselves updated as part of the back propagation process. The rate of weight update is set by a ‘learning rate’ hyperparameter, typically set to facilitate the training process in finding a global minima in terms of loss (i.e., highest possible task performance for the network architecture and training data) while avoiding the training process becoming ‘stuck’ in a local minima. Becoming stuck in a local minima corresponds to obtaining sub-optimal task performance for the network architecture and being incapable of finding new weight values that could lead to higher task performance. Network weights are repeatedly updated by supplying input data and ground truth data organised into ‘batches’ to iteratively refine the network performance until further improvement in accuracy is no longer achievable. An iteration through the entire training dataset forms one ‘epoch’ of training and training typically requires performing multiple epochs to achieve a high level of performance for the task. Weights for a trained network are then available for deployment, and the network operates in a mode where weights are fixed and gradients for weight update are omitted. The process of executing a pretrained CNN with an input and progressively transforming the input into an output according to a topology of the CNN is commonly referred to as ‘inferencing’.

Generally, a tensor has four dimensions, namely: batch, channels, height and width. The first dimension, ‘batch’, is typically of size one when inferencing on video data and indicates that one frame is passed through a CNN as one batch. When training a network, the value of the batch dimension may be increased so that multiple frames are passed through the network in each batch before the network weights are updated, according to a predetermined ‘batch size’. A multi-frame video may be passed through as a single tensor with the batch dimension increased in size according to the number of frames of a given video. However, for practical considerations relating to memory consumption and access, inferencing on video data is typically performed on a frame-wise basis. The ‘channels’ dimension indicates the number of concurrent ‘feature maps’ for a given tensor and the height and width dimensions indicate the size of the feature maps at the particular stage of the CNN. Channel count varies through the layers of a CNN according to the network architecture. Feature map size also varies, depending on subsampling or upsampling occurring in specific network layers.

The overall complexity of the CNN tends to be relatively high, with relatively large numbers of multiply-accumulate (MAC) operations being performed and numerous intermediate tensors being written to and read from memory, along with reading weights for performance of each layer of the CNN. As such, dividing a neural network into portions allows implementation of more complex networks even in systems containing less capable edge devices, without requiring cloud servers to bear the full burden of performing the network.

Feature compression may benefit from existing video compression standards, such as Versatile Video Coding (VVC), developed by the Joint Video Experts Team (JVET). VVC is anticipated to address ongoing demand for ever-higher compression performance, especially as video formats increase in capability (for example, with higher resolution and higher frame rate) and to address increasing market demand for service delivery over WANs, where bandwidth costs are relatively high. VVC is implementable in contemporary silicon processes and offers an acceptable trade-off between achieved performance versus implementation cost. The implementation cost may be considered for example, in terms of one or more of silicon area, CPU processor load, memory utilisation and bandwidth. Other video compression standards, such as High Efficiency Video Coding (HEVC) or AV-1, may also be used for feature compression applications.

Video data includes a sequence of frames of image data, each frame including one or more colour channels. Where feature map data is to be represented in a packed frame, generally a monochrome frame having luminance only and no chroma channels is adequate. When only luma samples are present, the resulting monochrome frames are said to use a “4:0:0 chroma format”.

The VVC standard specifies a ‘block based’ architecture, in which frames are firstly divided into an array of square regions known as ‘coding tree units’ (CTUs). In VVC, CTUs generally occupy 128×128 luma samples. Other possible CTU sizes when using the VVC standard are 32×32 and 64×64. However, CTUs at the right and bottom edge of each frame may be smaller in area, with implicit splitting occurring to ensure coding blocks remain in the frame. Associated with each CTU is a ‘coding tree’ defining a decomposition of the area of the CTU into a set of blocks, also referred to as ‘coding units’ (CUs). Blocks applicable to only the luma channel or only the chroma channels are referred to as ‘coding blocks’ (CBs). A prediction of the contents of a coding block is held in a ‘prediction block’ (PB) or ‘prediction unit’ (PU) and a residual block defining an array of sample values to be additively combined with the PB or PU is referred to as a ‘transform block’ (TB) or ‘transform unit’ (TU), owing to the typical use of a transformation process in the generation of the TB or TU.

Notwithstanding the above distinction between ‘units’ and ‘blocks’, the term ‘block’ may be used as a general term to refer to areas or regions of a frame for which operations are applied to all colour channels.

For each CU, a prediction unit (PU) of the contents (sample values) of the corresponding area of frame data is generated (a ‘prediction unit’). Further, a representation of the difference (or ‘spatial domain’ residual) between the prediction and the contents of the area as seen at input to the encoder is formed. The difference in each colour channel may be transformed and coded as a sequence of residual coefficients, forming one or more TUs for a given CU. The applied transform may be a Discrete Cosine Transform (DCT) or other transform, applied to each block of residual values. The transform is applied separably, (i.e., the two-dimensional transform is performed in two passes, one horizontally and one vertically). The block is firstly transformed by applying a one-dimensional transform to each row of samples in the block. Then, the partial result is transformed by applying a one-dimensional transform to each column of the partial result to produce a final block of transform coefficients that substantially decorrelates the residual samples. Transforms of various sizes are supported by the VVC standard, including transforms of rectangular-shaped blocks, with each side dimension being a power of two. Transform coefficients are quantised for entropy encoding into a bitstream.

PBs or PUs in VVC may be generated using either an intra-frame prediction or an inter-frame prediction process. Intra-frame prediction involves the use of previously processed samples in a frame being used to generate a prediction of a current block of data samples in the frame. Inter-frame prediction involves generating a prediction of a current block of samples in a frame using a block of samples obtained from one or two previously decoded frames. The block of samples obtained from a previously decoded frame is offset from the spatial location of the current block according to a motion vector, which often has filtering applied. Intra-frame prediction blocks can be (i) a uniform sample value (“DC intra prediction”), (ii) a plane having an offset and horizontal and vertical gradient (“planar intra prediction”), (iii) a population of the block with neighbouring samples applied in a particular direction (“angular intra prediction”) or (iv) the result of a matrix multiplication using neighbouring samples and selected matrix coefficients.

VVC may be used to compress intermediate feature maps from a first portion (a ‘backbone’) of a neural network separated into two portions. In compression, the feature maps from the backbone are arranged into a frame and quantised from a floating-point domain to a sample domain suitable for compression as video data. Techniques relating to principal component analysis (PCA) may be applied to reduce the dimensionality of the tensors prior to compression using a video compression standard such as VVC. Dimensionality reduction of tensors reduces the volume of data to be compressed, improving compression efficiency and reducing the runtime of the VVC encoding and decoding stages. Dimensionality reduction introduces complexity offsetting the reduction in runtime seen in the VVC encoding. A need exists to address, or at least ameliorate, the increase in complexity from applying PCA for dimensionality reduction of tensors.

### SUMMARY

It is an object of the present invention to substantially overcome, or at least ameliorate, one or more disadvantages of existing arrangements.

According to one aspect of the present disclosure, there is provided a method of decoding tensors for content of a bitstream, the method comprising:
determining a network topology from the bitstream;
decoding a first information from the bitstream; and
producing decoded tensors from the first information using the determined network topology.

According to another aspect of the present disclosure, there is provided a decoder for decoding tensors for content of a bitstream, the decoder configured to:
determine a network topology from the bitstream;
decode a first information from the bitstream; and
produce decoded tensors from the first information using the determined network topology.

According to still another aspect of the present disclosure, there is provided a non-transitory computer-readable medium which stores a program for executing a method of decoding tensors for content of a bitstream, the method comprising:
determining a network topology from the bitstream;
decoding a first information from the bitstream; and
producing decoded tensors from the first information using the determined network topology.

According to still another aspect of the present disclosure, there is provided a system comprising:
a memory; and
a processor, wherein the processor is configured to execute code stored on the memory for implementing a method of decoding tensors for content of a bitstream, the method comprising:
determining a network topology from the bitstream;
decoding a first information from the bitstream; and
producing decoded tensors from the first information using the determined network topology.

Other aspects are also disclosed.

### BRIEF DESCRIPTION OF THE DRAWINGS

At least one embodiment of the present invention will now be described with reference to the following drawings and an appendix, in which:

FIG. 1 is a schematic block diagram showing a distributed machine task system;

FIGS. 2A and 2B form a schematic block diagram of a general-purpose computer system upon which the distributed machine task system of FIG. 1 may be practiced;

FIG. 3A is a schematic block diagram showing functional modules of a backbone portion of a CNN;

FIG. 3B is a schematic block diagram showing a residual block of FIG. 3A;

FIG. 3C is a schematic block diagram showing a residual unit of FIG. 3A;

FIG. 3D is a schematic block diagram showing a CBL module of FIG. 3A;

FIG. 4 is a schematic block diagram showing functional modules of an alternative backbone portion of a CNN;

FIG. 5 is a schematic block diagram of a tensor encoder using a configurable tensor compressor stage;

FIG. 6 is a schematic block diagram showing a multi-scale feature fusion stage for a tensor compressor;

FIG. 7 is a schematic block diagram showing an inter-channel decorrelation-based tensor compressor;

FIG. 8 is a schematic block diagram showing functional modules of a video encoder;

FIGS. 9A & 9B are schematic block diagrams showing an arrangement of regions or subpictures for holding compressed tensor data;

FIGS. 10A & 10B are schematic block diagrams showing another arrangement of regions or subpictures for holding compressed tensor data;

FIG. 11 is a schematic block diagram showing a bitstream holding encoded inter-channel decorrelated feature maps and associated metadata;

FIG. 12 is a schematic block diagram showing a tensor decoder with a configurable tensor decompressor;

FIG. 13 is a schematic block diagram showing functional modules of a video decoder;

FIG. 14 is a schematic block diagram showing an inter-channel decorrelation-based tensor decoder as part of a distributed machine task system;

FIG. 15 is a schematic block diagram showing an embodiment of a multi-scale feature reconstruction stage;

FIG. 16A is a schematic block diagrams showing a head portion of a CNN;

FIG. 16B is a schematic block diagram showing an upscaler module of FIG. 16A;

FIG. 16C is a schematic block diagram showing a detection module of FIG. 16A;

FIG. 17 is a schematic block diagram showing an alternative head portion of a CNN;

FIG. 18 shows a method for performing a first portion of a CNN, selecting a tensor compressor, compressing tensors using the selected tensor compressor, and encoding resulting compressed tensors;

FIG. 19 shows a method for decoding a bitstream, reconstructing tensors according to an indicated tensor decompressor, and performing a second portion of the CNN;

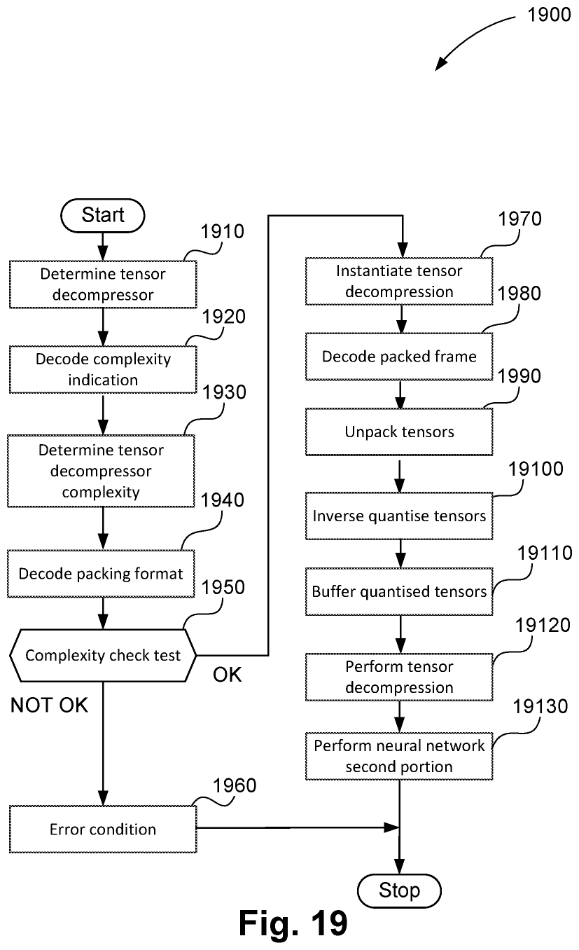

Appendix A shows a syntax table for a ‘supplementary enhancement information’ (SEI) message holding metadata necessary for operation of the decoding method of FIG. 19;

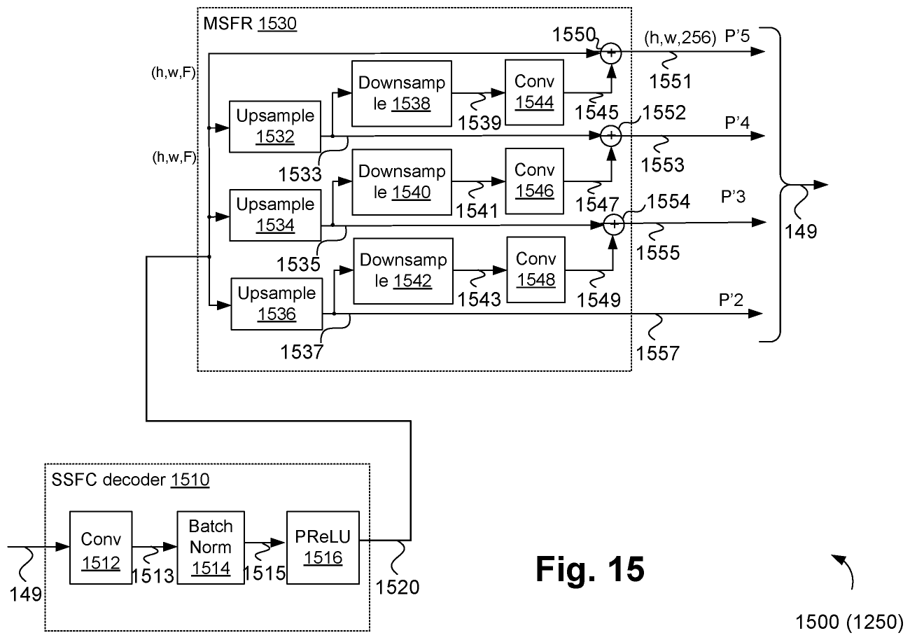

Appendix B shows a Python code fragment implementing the decoder network topology for the multi-scale feature reconstruction stage of FIG. 15; and

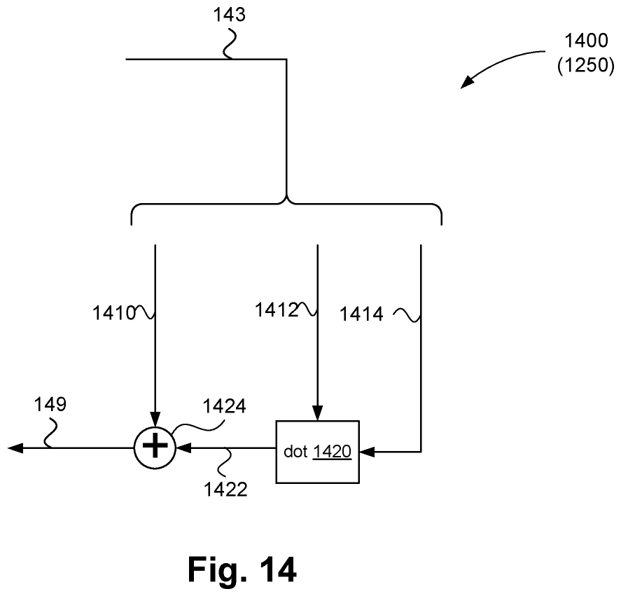

Appendix C shows a Python code fragment implementing the decoder network topology for the inter-channel decorrelation-based tensor decoder of FIG. 14.

### DETAILED DESCRIPTION INCLUDING BEST MODE

Where reference is made in any one or more of the accompanying drawings to steps and/or features, which have the same reference numerals, those steps and/or features have for the purposes of this description the same function(s) or operation(s), unless the contrary intention appears.

A distributed machine task system may include an edge device, such as a network camera or smartphone producing intermediate compressed data. The distributed machine task system may also include a final device, such as a server farm based (‘cloud’) application, operating on the intermediate compressed data to produce a task result. Additionally, the edge device functionality may be embodied in the cloud and the intermediate compressed data may be stored for later processing, potentially for multiple different tasks depending on need.

A convenient form of intermediate compressed data is a compressed video bitstream, owing to the availability of high-performing compression standards and implementations thereof. Video compression standards typically operate on integer samples of some given bit depth, such as 10 bits, arranged in planar arrays. Colour video has three planar arrays, corresponding, for example, to colour components Y, Cb, Cr, or R, G, B, depending on application. CNNs typically operate on floating point data in the form of tensors. Tensors generally have a relatively smaller spatial dimensionality compared to incoming video data upon which the CNN operates while having more channels than the three channels typical of colour video data, for example 128, 256, or 512 channels.

Tensors typically have the following dimensions: frames, channels, height, and width. For example, a tensor of dimensions [1, 256, 76, 136] would be said to contain floating-point or integer values for one frame comprising an array of two-hundred and fifty-six (256) feature maps (channels), each of size 136×76. For video data, inferencing is typically performed one frame at a time (frame value of 1), rather than using tensors containing multiple frames.

VVC supports a division of a picture into multiple subpictures, each of which may be independently encoded and independently decoded. In one approach, each subpicture is coded as one ‘slice’, or contiguous sequence of coded CTUs. A ‘tile’ mechanism is also available to divide a picture into a number of independently decodeable regions. Subpictures may be specified in a somewhat flexible manner, with various rectangular sets of CTUs coded as respective subpictures. Flexible definition of subpicture dimensions allows efficiently holding types of data requiring different areas in one picture, avoiding large ‘unused’ areas, i.e., areas of a frame that are not used for reconstruction of tensor data.

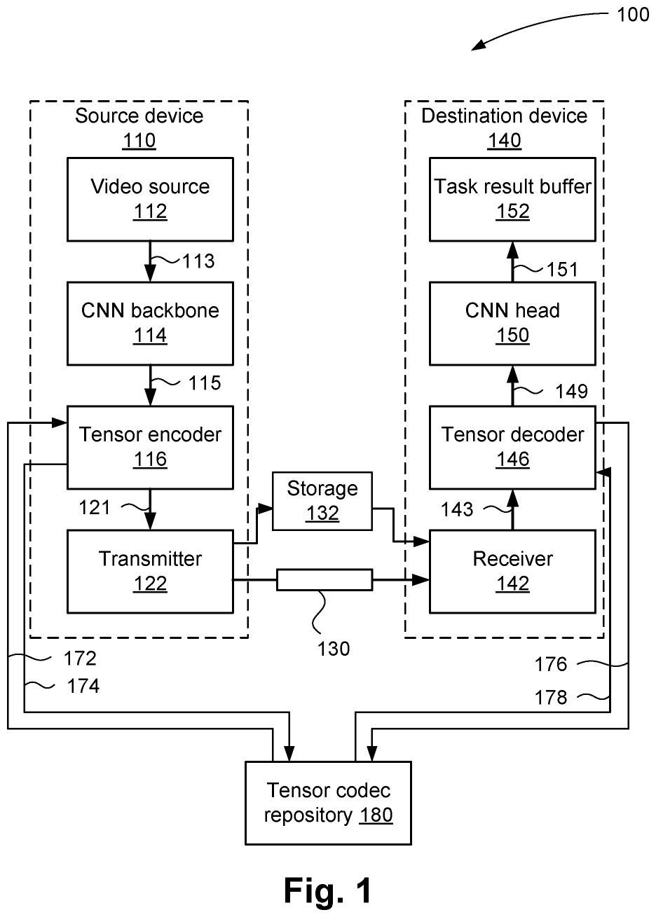

FIG. 1 is a schematic block diagram showing functional modules of a distributed machine task system 100, capable of performing a machine task network in a distributed manner. The division of a particular neural network into two portions requires specifying a ‘split point’ in the network. Layers in the network from the input layer up to the split point are performed in a first device and the resulting intermediate tensor(s) are compressed. Layers from the split point up to the last layer in the network are performed using decompressed tensor(s) from the first device as input to the layer(s) immediately following the split point. At the split point there may be one or more tensors that need to be compressed for conveyance over a communication channel with limited bandwidth compared to the bandwidth requirement for transmission of uncompressed tensors. Where a ‘feature pyramid network’ (FPN) is in use, it is common for layers in the FPN to be related in width and height such that a given layer is half the width and height of an adjacent layer among the layers. FPN architectures may also involve the width and height halving alternatively from one layer to the next layer. In some architectures, multiple tensors of the same width and height are produced within the FPN. An FPN may occur relatively early in the neural network topology, resulting in a necessity for a split point to occur within the FPN in order for a useful division of the network workload across the edge device and the cloud to be achieved. When a split occurs within the FPN of the machine task network, performance of a variety of machine task networks where layers up to the split point are common among the machine task networks (‘shared backbone’ architecture) may be achieved. Where a split point occurs within the FPN, tensor compression methods may exploit redundancies across the FPN layers to improve compression performance. Compression methods applicable to the various network topologies used in contemporary CNNs are therefore beneficial for application in a wide range of scenarios.

The system 100 may be used for implementing methods for decorrelating, packing and quantising feature maps into planar frames for encoding and decoding feature maps from encoded data for various neural networks. Various neural networks may be split at different points and may result in intermediate tensors of various number and dimensionality. A feature compression scheme capable of adapting to different types of intermediate data and capable of providing different quality reconstruction results in advantageous flexibility. Moreover, the system 100 provides flexibility to interface neural networks of various architectures and for various applications subjected to splitting into portions (e.g., for distributed execution).

The system 100 includes a source device 110 for generating encoded frame data 113. The frame data 113 is passed to a CNN backbone 114 to produce tensors 115. The tensors 115 are passed to a tensor encoder 116, which produces an encoded bitstream 121. The system 100 also includes a destination device 140 for decoding tensor data in the form of a received bitstream 143. The destination device 140 may be used for decoding the tensor data (or tensors) for content (e.g., of audio data, video data, image data, and textual data) of the bitstream 143.

A communication channel 130 is used to communicate the encoded bitstream 121 from the source device 110 to the destination device 140. In some arrangements, the source device 110 and destination device 140 may either or both comprise respective mobile telephone handsets (e.g., “smartphones”) or network cameras and cloud applications. The communication channel 130 may be a wired connection, such as Ethernet, or a wireless connection, such as WiFi or 5G, including connections across a Wide Area Network (WAN). The communication channel 130 may also be implemented across ad-hoc connections. Moreover, the source device 110 and the destination device 140 may comprise applications where encoded video data is captured on some computer-readable storage medium, such as a hard disk drive in a file server or memory. Although the system 100 is described as including the video source 112, which would provide the frame data 113 for a neural network targeting a computer vision application, other types of source data, such as audio or text, may be input to a suitable neural network implemented in the CNN backbone 114 and the CNN head 150.

As shown in FIG. 1, the source device 110 includes a video source 112, the CNN backbone 114, a tensor encoder 116, and a transmitter 122. The video source 112 typically comprises a source of captured video frame data (shown as 113), such as an image capture sensor, a previously captured video sequence stored on a non-transitory recording medium, or a video feed from a remote image capture sensor. The video source 112 may also be an output of a computer graphics card, for example, displaying the video output of an operating system and various applications executing upon a computing device (e.g., a tablet computer). Examples of source devices 110 that may include an image capture sensor as the video source 112 include smart-phones, video camcorders, professional video cameras, and network video cameras. The video source 112 may produce independent images or may produce temporally sequential images, i.e., a video.

The neural network implemented in the CNN backbone 114 and the CNN head 150 may depend on the application. For example, a ‘YOLOv3’ network may be used as one part of an object tracking system and a ‘FasterRCNN’ network may be used as an object detection system. The number and dimensionality of tensors 115 depends on a particular network performed in the system 100 and the split point of the particular network.

The CNN backbone 114 receives the video frame data 113 and performs specific layers of an overall CNN, such as layers corresponding to the ‘backbone’ of the CNN, outputting tensors 115a. The backbone layers of the CNN may produce multiple tensors as output, for example, corresponding to different spatial scales of an input image represented by the video frame data 113 when splitting the network within the FPN. An FPN may result in three tensors, corresponding to three layers, output from the backbone 114 as the tensors 115a (e.g., if a ‘YOLOv3’ network is performed by the system 100), with varying spatial resolution and channel count. When the system 100 is performing networks such as ‘Faster RCNN X101-FPN’ or ‘Mask RCNN X101-FPN’ the tensors 115a may include tensors for four layers (P2-P5). Use of a FPN results in a plurality of tensors forming a hierarchical representation for a single frame to be encoded to (and decoded from) the bitstream when the split point of the network occurs within the FPN, as described hereafter.

The bitstream 121 is supplied to the transmitter 122 for transmission over the communications channel 130 or the bitstream 121 is written to storage 132 for later use.

The source device 110 supports a particular network for the CNN backbone 114. However, the destination device 140 may use one of several networks for a head CNN 150. In using one of several networks for the head CNN 150, partially processed data in the form of packed feature maps may be stored for later use in performing various tasks without needing to again perform the operation of the CNN backbone 114.

The bitstream 121 is transmitted by the transmitter 122 over the communication channel 130 as encoded data. The bitstream 121 can in some implementations be stored in a storage memory 132, where the storage 132 is a non-transitory storage device such as a “Flash” memory or a hard disk drive, until later being transmitted over the communication channel 130 (or in-lieu of transmission over the communication channel 130). For example, encoded video data may be served upon demand to customers over a wide area network (WAN) for a video analytics application.

The destination device 140 includes a receiver 142, a tensor decoder 146, the CNN head 150, and a CNN task result buffer 152. The receiver 142 receives encoded video data from the communication channel 130 and passes the bitstream 143 to the tensor decoder 146. The tensor decoder 146 outputs decoded tensors 149, which are supplied to the CNN head 150. The CNN head 150 receives the tensors 149 and performs the later layers of the neural network that began with the CNN backbone 114 to produce a task result 151. The task result 151 is stored in the task result buffer 152. The contents of the task result buffer 152 may be presented to the user (e.g., via a graphical user interface), or provided to an analytics application where some action is decided based on the task result, which may include summary level presentation of aggregated task results to a user. It is also possible for the functionality of each of the source device 110 and the destination device 140 to be embodied in a single device, examples of which include mobile telephone handsets and tablet computers and cloud applications.

As seen in FIG. 1, the system 100 comprises a tensor codec repository 180 which may include network topologies covering a variety of neural networks and associated split points, and reconstruction fidelity levels. The network topologies may be stored in in the tensor codec repository 180 for future reference (or use). The tensor codec repository 180 may be access ‘out of band’ or separately stored in each of the source device 110 and the destination device 140. A network topology identifier 174 and 176 may be sent by the tensor encoder 116 and the tensor decoder 146, respectively. The network topology identifiers 174 and 176 may be used for determining a given network topology from the bitstream 143.

As a result of a request for a given network topology, a network topology 172 and 178 may be returned to the tensor encoder 16 and the tensor decoder 146, respectively. As described in detail below, the information including the network topology identifier 178 may be decoded and used by the tensor decoder 146 for producing decoded tensors using the determined network topology. The tensor codec repository 180 may be accessible via public file repository or within a private network accessible to the source device 110 and the destination device 140.

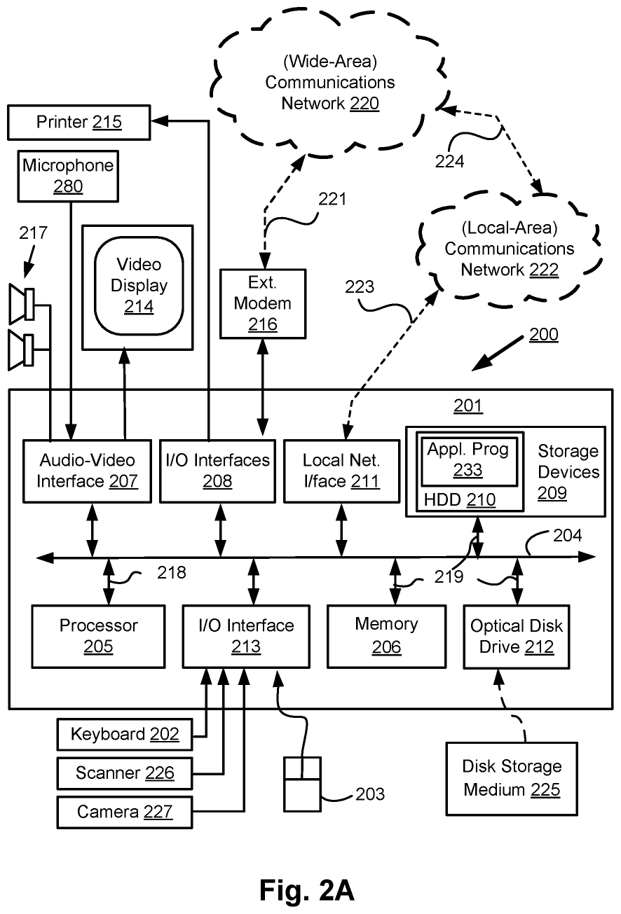

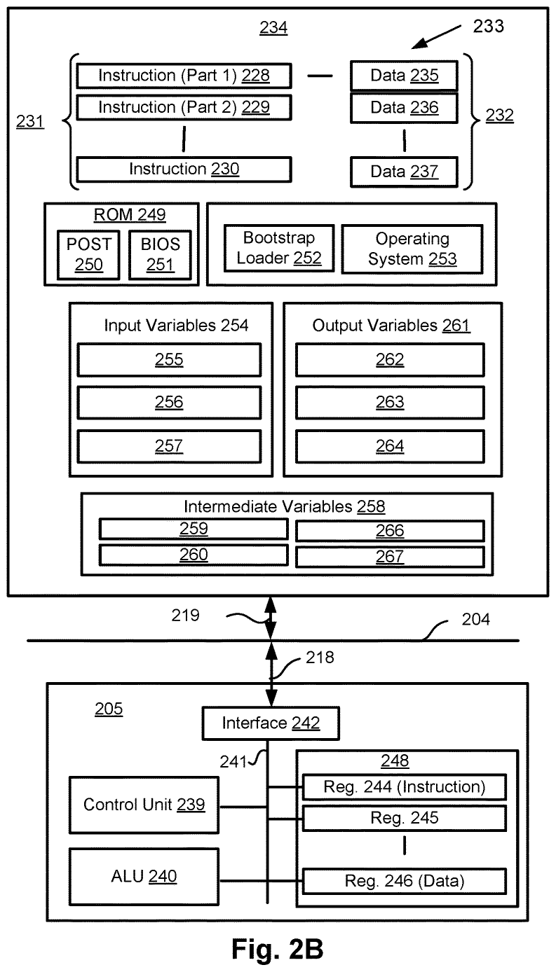

Notwithstanding the example devices mentioned above, each of the source device 110 and destination device 140 may be configured within a general-purpose computing system, typically through a combination of hardware and software components. FIG. 2A illustrates such a computer system 200, which includes: a computer module 201; input devices such as a keyboard 202, a mouse pointer device 203, a scanner 226, a camera 227, which may be configured as the video source 112, and a microphone 280; and output devices including a printer 215, a display device 214 and loudspeakers 217. An external Modulator-Demodulator (Modem) transceiver device 216 may be used by the computer module 201 for communicating to and from a communications network 220 via a connection 221. The communications network 220, which may represent the communication channel 130, may be a (WAN), such as the Internet, a cellular telecommunications network, or a private WAN. Where the connection 221 is a telephone line, the modem 216 may be a traditional “dial-up” modem. Alternatively, where the connection 221 is a high capacity (e.g., cable or optical) connection, the modem 216 may be a broadband modem. A wireless modem may also be used for wireless connection to the communications network 220. The transceiver device 216 may provide the functionality of the transmitter 122 and the receiver 142 and the communication channel 130 may be embodied in the connection 221.

The computer module 201 typically includes at least one processor unit 205, and a memory unit 206. For example, the memory unit 206 may have semiconductor random access memory (RAM) and semiconductor read only memory (ROM). The computer module 201 also includes a number of input/output (I/O) interfaces including: an audio-video interface 207 that couples to the video display 214, loudspeakers 217 and microphone 280; an I/O interface 213 that couples to the keyboard 202, mouse 203, scanner 226, camera 227 and optionally a joystick or other human interface device (not illustrated); and an interface 208 for the external modem 216 and printer 215. The signal from the audio-video interface 207 to the computer monitor 214 is generally the output of a computer graphics card. In some implementations, the modem 216 may be incorporated within the computer module 201, for example within the interface 208. The computer module 201 also has a local network interface 211, which permits coupling of the computer system 200 via a connection 223 to a local-area communications network 222, known as a Local Area Network (LAN). As illustrated in FIG. 2A, the local communications network 222 may also couple to the wide network 220 via a connection 224, which would typically include a so-called “firewall” device or device of similar functionality. The local network interface 211 may comprise an Ethernet™ circuit card, a Bluetooth™ wireless arrangement or an IEEE 802.11 wireless arrangement; however, numerous other types of interfaces may be practiced for the interface 211. The local network interface 211 may also provide the functionality of the transmitter 122 and the receiver 142 and communication channel 130 may also be embodied in the local communications network 222.

The I/O interfaces 208 and 213 may afford either or both of serial and parallel connectivity, the former typically being implemented according to the Universal Serial Bus (USB) standards and having corresponding USB connectors (not illustrated). Storage devices 209 are provided and typically include a hard disk drive (HDD) 210. Other storage devices such as a floppy disk drive and a magnetic tape drive (not illustrated) may also be used. An optical disk drive 212 is typically provided to act as a non-volatile source of data. Portable memory devices, such optical disks (e.g., CD-ROM, DVD, Blu ray Disc™), USB-RAM, portable, external hard drives, and floppy disks, for example, may be used as appropriate sources of data to the computer system 200. Typically, any of the HDD 210, optical drive 212, networks 220 and 222 may also be configured to operate as the video source 112, or as a destination for decoded video data to be stored for reproduction via the display 214. The source device 110 and the destination device 140 of the system 100 may be embodied in the computer system 200.

The components 205 to 213 of the computer module 201 typically communicate via an interconnected bus 204 and in a manner that results in a conventional mode of operation of the computer system 200 known to those in the relevant art. For example, the processor 205 is coupled to the system bus 204 using a connection 218. Likewise, the memory 206 and optical disk drive 212 are coupled to the system bus 204 by connections 219. Examples of computers on which the described arrangements can be practised include IBM-PC's and compatibles, Sun SPARCstations, Apple Mac™ or alike computer systems.

The tensor encoder 116, the tensor decoder 146 and methods to be described, may be implemented as one or more software application programs 233 executable within the computer system 200. In particular, the tensor encoder 116, the tensor decoder 146 and the steps of the described methods are effected by instructions 231 (see FIG. 2B) in the software 233 that are carried out within the computer system 200. The software instructions 231 may be formed as one or more code modules, each for performing one or more particular tasks. The software may also be divided into two separate parts, in which a first part and the corresponding code modules performs the described methods and a second part and the corresponding code modules manage a user interface between the first part and the user.

The software may be stored in a computer readable medium, including the storage devices described below, for example. The software is loaded into the computer system 200 from the computer readable medium, and then executed by the computer system 200. A computer readable medium having such software or computer program recorded on the computer readable medium is a computer program product. The use of the computer program product in the computer system 200 preferably effects an advantageous apparatus for implementing the source device 110 and the destination device 140 and the described methods.

The software 233 is typically stored in the HDD 210 or the memory 206. The software is loaded into the computer system 200 from a computer readable medium and is executed by the computer system 200. Thus, for example, the software 233 may be stored on an optically readable disk storage medium (e.g., CD-ROM) 225 that is read by the optical disk drive 212.

In some instances, the application programs 233 may be supplied to the user encoded on one or more CD-ROMs 225 and read via the corresponding drive 212, or alternatively may be read by the user from the networks 220 or 222. Still further, the software can also be loaded into the computer system 200 from other computer readable media. Computer readable storage media refers to any non-transitory tangible storage medium that provides recorded instructions and/or data to the computer system 200 for execution and/or processing. Examples of such storage media include floppy disks, magnetic tape, CD-ROM, DVD, Blu-ray Disc™, a hard disk drive, a ROM or integrated circuit, USB memory, a magneto-optical disk, or a computer readable card such as a PCMCIA card and the like, whether or not such devices are internal or external of the computer module 201. Examples of transitory or non-tangible computer readable transmission media that may also participate in the provision of the software, application programs, instructions and/or video data or encoded video data to the computer module 201 include radio or infra-red transmission channels, as well as a network connection to another computer or networked device, and the Internet or Intranets including e-mail transmissions and information recorded on Websites and the like.

The second part of the application program 233 and the corresponding code modules mentioned above may be executed to implement one or more graphical user interfaces (GUIs) to be rendered or otherwise represented upon the display 214. Through manipulation of typically the keyboard 202 and the mouse 203, a user of the computer system 200 and the application may manipulate the interface in a functionally adaptable manner to provide controlling commands and/or input to the applications associated with the GUI(s). Other forms of functionally adaptable user interfaces may also be implemented, such as an audio interface utilizing speech prompts output via the loudspeakers 217 and user voice commands input via the microphone 280.

FIG. 2B is a detailed schematic block diagram of the processor 205 and a “memory” 234. The memory 234 represents a logical aggregation of all the memory modules (including the storage devices 209 and semiconductor memory 206) that can be accessed by the computer module 201 in FIG. 2A.

When the computer module 201 is initially powered up, a power-on self-test (POST) program 250 executes. The POST program 250 is typically stored in a ROM 249 of the semiconductor memory 206 of FIG. 2A. A hardware device such as the ROM 249 storing software is sometimes referred to as firmware. The POST program 250 examines hardware within the computer module 201 to ensure proper functioning and typically checks the processor 205, the memory 234 (209, 206), and a basic input-output systems software (BIOS) module 251, also typically stored in the ROM 249, for correct operation. Once the POST program 250 has run successfully, the BIOS 251 activates the hard disk drive 210 of FIG. 2A. Activation of the hard disk drive 210 causes a bootstrap loader program 252 that is resident on the hard disk drive 210 to execute via the processor 205. This loads an operating system 253 into the RAM memory 206, upon which the operating system 253 commences operation. The operating system 253 is a system level application, executable by the processor 205, to fulfil various high-level functions, including processor management, memory management, device management, storage management, software application interface, and generic user interface.

The operating system 253 manages the memory 234 (209, 206) to ensure that each process or application running on the computer module 201 has sufficient memory in which to execute without colliding with memory allocated to another process. Furthermore, the different types of memory available in the computer system 200 of FIG. 2A need to be used properly so that each process can run effectively. Accordingly, the aggregated memory 234 is not intended to illustrate how particular segments of memory are allocated (unless otherwise stated), but rather to provide a general view of the memory accessible by the computer system 200 and how such memory is used.

As shown in FIG. 2B, the processor 205 includes a number of functional modules including a control unit 239, an arithmetic logic unit (ALU) 240, and a local or internal memory 248, sometimes called a cache memory. The cache memory 248 typically includes a number of storage registers 244-246 in a register section. One or more internal busses 241 functionally interconnect these functional modules. The processor 205 typically also has one or more interfaces 242 for communicating with external devices via the system bus 204, using the connection 218. The memory 234 is coupled to the bus 204 using the connection 219.

The application program 233 includes a sequence of instructions 231 that may include conditional branch and loop instructions. The program 233 may also include data 232 which is used in execution of the program 233. The instructions 231 and the data 232 are stored in memory locations 228, 229, 230 and 235, 236, 237, respectively. Depending upon the relative size of the instructions 231 and the memory locations 228-230, a particular instruction may be stored in a single memory location as depicted by the instruction shown in the memory location 230. Alternately, an instruction may be segmented into a number of parts each of which is stored in a separate memory location, as depicted by the instruction segments shown in the memory locations 228 and 229.

In general, the processor 205 is given a set of instructions which are executed therein. The processor 205 waits for a subsequent input, to which the processor 205 reacts to by executing another set of instructions. Each input may be provided from one or more of a number of sources, including data generated by one or more of the input devices 202, 203, data received from an external source across one of the networks 220, 202, data retrieved from one of the storage devices 206, 209 or data retrieved from a storage medium 225 inserted into the corresponding reader 212, all depicted in FIG. 2A. The execution of a set of the instructions may in some cases result in output of data. Execution may also involve storing data or variables to the memory 234.

The tensor encoder 116, the tensor decoder 146 and the described methods may use input variables 254, which are stored in the memory 234 in corresponding memory locations 255, 256, 257. The tensor encoder 116, the tensor decoder 146 and the described methods produce output variables 261, which are stored in the memory 234 in corresponding memory locations 262, 263, 264. Intermediate variables 258 may be stored in memory locations 259, 260, 266 and 267.

Referring to the processor 205 of FIG. 2B, the registers 244, 245, 246, the arithmetic logic unit (ALU) 240, and the control unit 239 work together to perform sequences of micro-operations needed to perform “fetch, decode, and execute” cycles for every instruction in the instruction set making up the program 233. Each fetch, decode, and execute cycle comprises:
a fetch operation, which fetches or reads an instruction 231 from a memory location 228, 229, 230;
a decode operation in which the control unit 239 determines which instruction has been fetched; and
an execute operation in which the control unit 239 and/or the ALU 240 execute the instruction.

Thereafter, a further fetch, decode, and execute cycle for the next instruction may be executed. Similarly, a store cycle may be performed by which the control unit 239 stores or writes a value to a memory location 232.

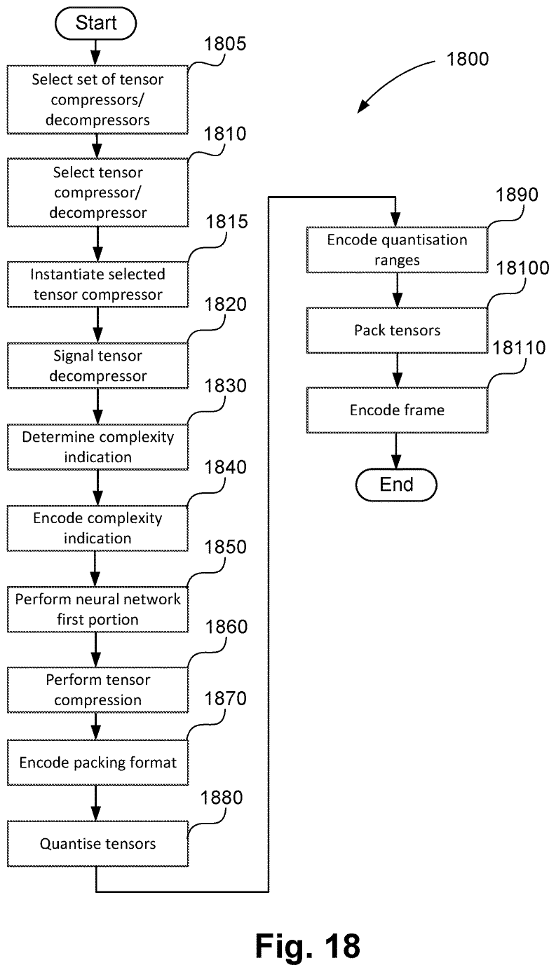

Each step or sub-process in the methods of FIGS. 18 and 19, to be described, is associated with one or more segments of the program 233 and is typically performed by the register section 244, 245, 246, the ALU 240, and the control unit 239 in the processor 205 working together to perform the fetch, decode, and execute cycles for every instruction in the instruction set for the noted segments of the program 233.

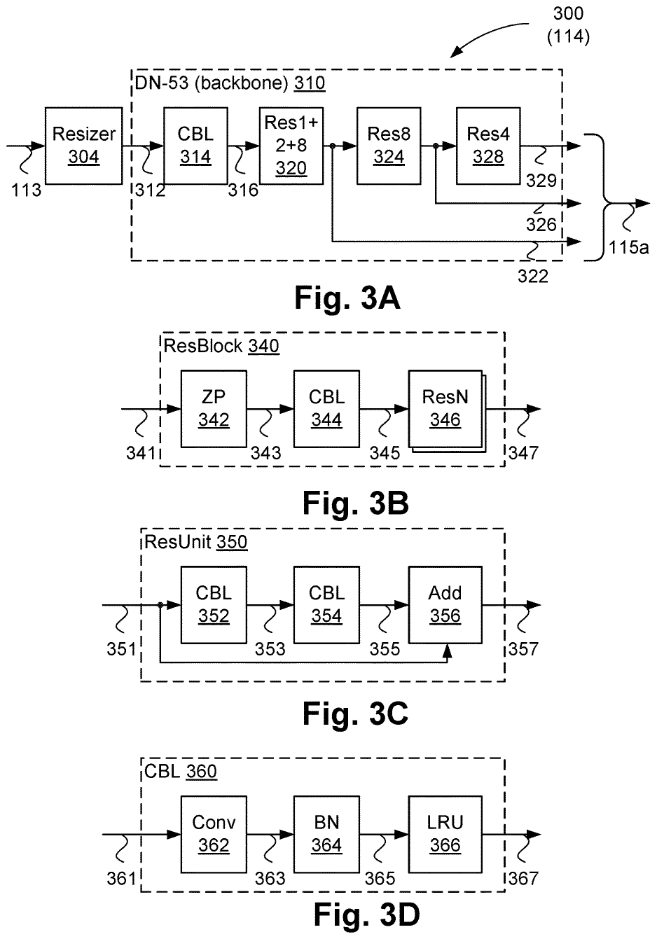

FIG. 3A is a schematic block diagram 300 showing functional modules of a backbone portion 310 of a CNN, which may serve as an implementation of the CNN backbone 114 when the system 100 is configured to perform a ‘YOLOv3’ network. The backbone portion 114 is sometimes referred to as ‘DarkNet-53’, although different backbones are also possible, resulting in a different number of and dimensionality of layers of the tensors 115 for each frame. In one implementation, the backbone portion 310 may be used as a person detector for the purpose of object tracking.

As shown in FIG. 3A, the video data 113 is passed to a resizer module 304. The resizer module 304 resizes each frame of the video data 113 to a resolution suitable for processing by the CNN backbone 310, producing resized frame data 312. If the resolution of the video data 113 is already suitable for the CNN backbone 310, operation of the resizer module 304 is not needed. The resized frame data 312 is passed to a convolutional batch normalisation leaky rectified linear (CBL) module 314 to produce tensors 316. The CBL module 314 contains modules as described with reference to a CBL module 360 as shown in FIG. 3D.

The CBL module 360 takes as input a tensor 361 of the resized frame data 312. The tensor 361 is passed to a convolutional layer 362 to produce tensor 363. If the convolutional layer 362 has a stride of one, the tensor 363 has the same spatial dimensions as the tensor 361. If the convolution layer 362 has a larger stride, such as two, the tensor 363 has smaller spatial dimensions compared to the tensor 361, for example, halved in width and height for the stride of two. Regardless of the stride, the size of channel dimension of the tensor 363 may vary compared to the channel dimension of the tensor 361 for a particular CBL block. The tensor 363 is passed to a batch normalisation module 364, which outputs a tensor 365. The batch normalisation module 364 normalises the input tensor 363 and applies a scaling factor and an offset value to produce the output tensor 365. The scaling factor and offset value are derived from a training process. The tensor 365 is passed to a leaky rectified linear activation (“LeakyReLU”) module 366 to produce a tensor 367. The module 366 provides a ‘leaky’ activation function whereby positive values in the tensor are passed through and negative values are severely reduced in magnitude, for example, to 0.1× their former value.

Returning to FIG. 3A, the tensor 316 is passed from the CBL block 314 to a residual block module 320, such as a ‘res1+2+8’ module (also referred to as a res11 module) containing a concatenation of three residual blocks, each residual block containing one (1) residual unit, two (2) residual units, and eight (8) residual units, respectively. The spatial resolution of the tensors is halved horizontally and halved vertically in each of the residual blocks (see FIG. 3B) by a convolution with stride equal to two in a CBL block 344.

A residual block is described with reference to a ResBlock 340 as shown in FIG. 3B. The ResBlock 340 receives a tensor 341. The tensor 341 is zero-padded by a zero-padding module 342 to produce a tensor 343. The tensor 343 is passed to the CBL module 344 to produce a tensor 345. The CBL module 344 contains a convolution (for example 362) with a stride parameter set to two, resulting in the tensor 345 having half the width and half the height of the tensor 343. The tensor 345 is passed to a residual unit 346. The residual unit 346 contains a series of concatenated residual units, based on the number of residual block (for example, eleven (11) units for the block 320). The last residual unit of the residual units 346 outputs a tensor 347.

A residual unit is described with reference to a ResUnit 350 as shown in FIG. 3C. The ResUnit 350 takes a tensor 351 as input. The tensor 351 is passed to a CBL module 352 to produce a tensor 353. The tensor 353 is passed to a second CBL unit 354 to produce a tensor 355. An add module 356 sums the tensor 355 with the tensor 351 to produce a tensor 357. The add module 356 may also be referred to as a ‘shortcut’ as the input tensor 351 substantially influences the output tensor 357. For an untrained network, ResUnit 350 acts to pass-through tensors. As training is performed, the CBL modules 352 and 354 act to deviate the tensor 357 away from the tensor 351 in accordance with training data and ground truth data.

Returning to FIG. 3A, the Res11 module 320 outputs a tensor 322. The tensor 322 is output from the backbone module 310 as one of the layers and also provided to a Res8 module 324. The Res8 module 324 is a residual block (i.e., 340), which includes eight residual units (i.e. 350). The Res8 module 324 produces a tensor 326. The tensor 326 is passed to a Res4 module 328 and output from the backbone module 310 as one of the layers. The Res4 module is a residual block (i.e., 340), which includes four residual units (i.e., 350). The Res4 module 328 produces a tensor 329. The tensor 329 is output from the backbone module 310 as one of the layers. Collectively, the layer tensors 322, 326, and 329 are output as the tensors 115a and may be referred to as layers 0-2 or L0, L1, and L2, respectively. The backbone CNN 310 may take as input a video frame of resolution 1088×608 and produce three tensors, corresponding to three layers, with the following dimensions: [1, 256, 76, 136], [1, 512, 38, 68], [1, 1024, 19, 34]. Another example of the three tensors 115a corresponding to three layers may be [1, 512, 34, 19], [1, 256, 68, 38], [1, 128, 136, 76] which are respectively separated at layer index 75, 90, and 105 when the layers are enumerated according to the YOLOv3 software implementation of the backbone 300 and the head 1200.

Each of the Res11 320, Res8 324 and Res4 328 operates in a similar manner to ResBlock 340. Each of the CBL 314, the CBL 344 and the CBL 354 operate in a similar manner to the CBL 360.

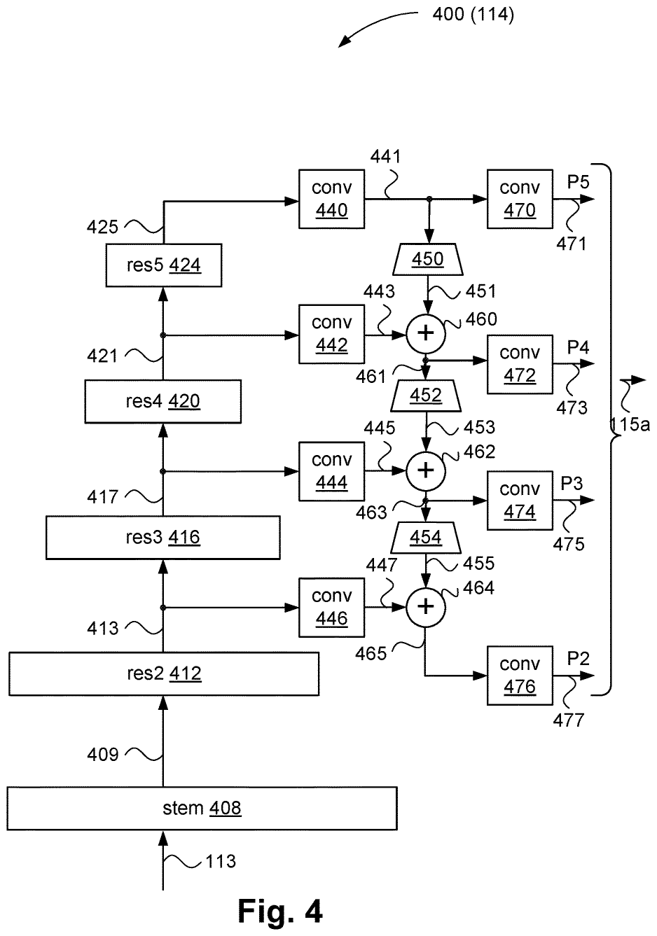

FIG. 4 is a schematic block diagram showing functional modules of an alternative backbone portion 400 of a CNN, which may serve as an implementation of the CNN backbone 114 when the system 100 is configured to perform a “FasterRCNN” or “MaskRCNN” ResNet 101 network. Frame data 113 is input and passes through a stem network 408, a res2 module 412, a res3 module 416, a res4 module 420, and a res5 module 424 via tensors 409, 413, 417, 421, 425 respectively. The backbone portion 400 may be used as part of a general object detector or for instance segmentation, with various classes of object supported.

The stem network 408 includes a 7×7 convolution with a stride of two (2) and a max pooling operation. The res2 module 412, the res3 module 416, the res4 module 420 and the res5 module 424 perform convolution operations, such as LeakyReLU activations. Each module 412, 416, 420 and 424 also performs one halving of the width and height of the processed tensors via a stride setting of two. Each of the tensors 413, 417, 421 and 425 are passed to one of 1×1 lateral convolution modules 446, 444, 442 and 440 respectively. The modules 446, 444, 442, and 440 produce tensors 447, 445, 443 and 441 respectively. The tensor 441 is passed to a 3×3 output convolution module 470, which produces an output tensor P5 471.

The tensor 441 is also passed to upsampler module 450 to produce an upsampled tensor 451. A summation module 460 sums the tensors 443 and 451 to produce a tensor 461. The tensor 461 is passed to an upsampler module 452 and a 3×3 lateral convolution module 472. The module 472 outputs a P4 tensor 473. The upsampler module 452 produces an upsampled tensor 453. A summation module 462 sums tensors 445 and 453 to produce a tensor 463. The tensor 463 is passed to a 3×3 lateral convolution module 474 and an upsampler module 454. The module 474 outputs a P3 tensor 475. The upsampler module 454 outputs an upsampled tensor 455. A summation module 464 sums the tensors 447 and 455 to produce tensor 465, which is passed to a 3×3 lateral convolution module 476. The module 476 outputs a P2 tensor 477. The upsampler modules 450, 452, and 454 use nearest neighbour interpolation for low computational complexity. The tensors 471, 473, 475, and 477 form the output tensor 115a of the CNN backbone 400. Although FIG. 4 shows a particular backbone portion of the Faster RCNN network architecture (a ‘P-layer split point), different divisions into backbone and head are possible. Splitting the network at tensor 409 is termed a ‘stem’ split point. Splitting the network at tensors 447, 445, 443, and 441 is termed a ‘C-layer’ split point.

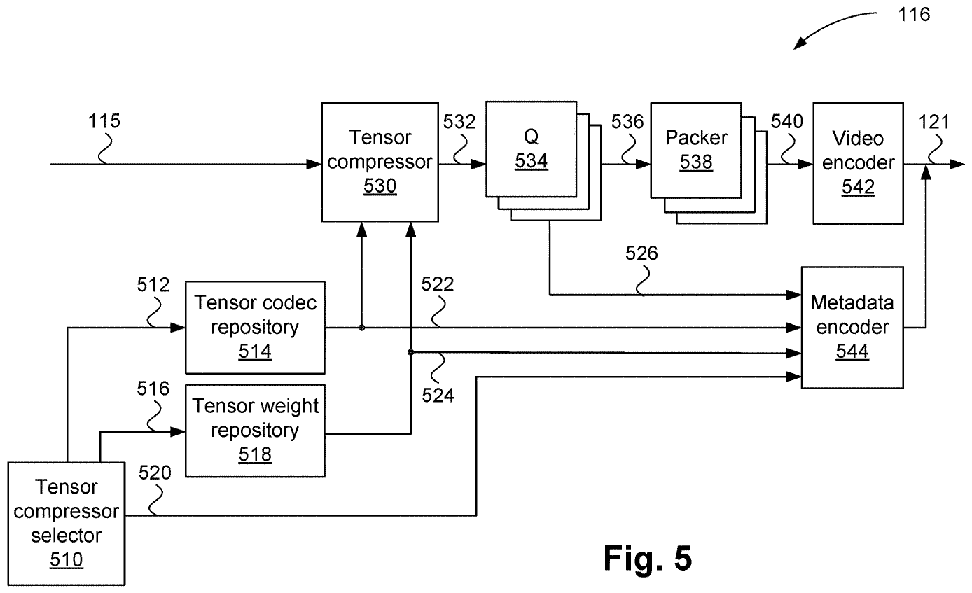

FIG. 5 is a schematic block diagram of the tensor encoder 116 using a configurable tensor compressor stage. FIG. 18 shows a method 1800 for performing a first portion of a CNN, selecting a tensor compressor, compressing tensors using the selected tensor compressor, and encoding resulting compressed tensors. The tensor encoder 116 and the method 1800 may be implemented as one or more software application programs 233 executable within the computer system 200. The tensor encoder 116 and the method 1800 may be effected by instructions 231 (see FIG. 2B) in the software 233 that are carried out within the computer system 200. The software instructions 231 may be formed as one or more code modules, each for performing one or more particular tasks. The method 1800 commences at a select set of tensor compressors/decompressors step 1805.

At the step 1805, a tensor compressor selector 510, under execution of the processor 205, selects a set of mechanisms that may be used for compressing and decompressing intermediate tensors. Each mechanism of the set forms a ‘bottleneck’ and corresponds to an encoder network topology coupled to a decoder network topology. The interface between the encoder network topology and the decoder network topology is the narrowest and hence most dimensionality reduced layer. The interface also includes one or more tensors that may be referred to as ‘compressed tensors’. The one or more tensors may be produced from operations such as convolutions, batch normalisations, activation functions, or matrix multiplications, tensor additions and/or subtractions. The dimensionality of tensors at the interface may vary from one invocation of the method 1800 to a next invocation of the method 1800 (e.g., the channel count may vary). Support for a plurality of mechanisms in one bitstream enables adapting to changing network conditions and application requirements by switching form one mechanism to another dynamically. For example, an object segmentation network may operate using a mechanism providing low bitrate at the expense of lower quality output (resulting in lower mAP) of the task result 151 from the CNN head 150.

If the consumer of the task result 151 determines that the particular bitstream contains content (e.g., audio data, video data, image data, and textual data) of high interest, then the source device 110 may be requested to increase the quality (and hence the bitrate) of the bitstream 121. The dimensionality of the intermediate tensors (e.g., the tensors 115) depends on the specific neural network being performed by the system 100 and the division of the network into the first portion and the second portion.

Each mechanism selected at the step 1805 needs to match the dimensionality of the tensors 115 at the input to the encoder network topology and output of the decoder network topology in order to be compatible with the neural network. Tensors in compressed form, (i.e., at the ‘bottleneck’ point or output from the encoder network topology and input to the decoder network topology), may have varying number and dimensionality. Where a mechanism involves the use of trainable elements, such as convolutions, the tensor compressor selector 510 also determines selected weights 516 to be used by the encoder network topology and the decoder network topology. Multiple weights may be available for a given encoder network topology and decoder network topology, such as different weights targeting different quality operating points. Control in the processor 205 progresses from the step 1805 to a select tensor compressor/decompressor step 1810.

At the step 1810 a tensor compressor selector 510, under execution of the processor 205, selects a mechanism to be used for compression and decompression of the tensors 115, outputting a selected tensor decompressor 512 and associated metadata 520. The selection made at the step 1810 is from the set determined at the step 1805. The selection may be the result of a request by the destination device via an out-of-band signalling mechanism to increase or decrease the decoded quality (and hence the bitstrate) of the bitstream 121. Where a mechanism is parameterizable (e.g., the channel count of one or more of the compressed tensors may be varied dynamically), a suitable value is selected at the step 1810.

The system 100 performs a given neural network which is divided into a first portion, performed by the CNN backbone 114, and a second portion, performed by the CNN head 150. The first portion of the neural network may be a Darknet-53 backbone as described with reference to FIGS. 3A-3D, a backbone of a FasterRCNN or MaskRCNN network, as described with reference to FIG. 4, or a first portion of some other neural network. The number and dimensionality of the tensors 115 depends on the network being implemented in the system 100 and the division of the network into a first portion, executed in the CNN backbone 114, and a second portion, executed in the CNN head 150. Such mechanisms involve an encoder network topology, to be performed in the source device 110, and a decoder network topology, to be performed in the destination device 140. The encoder network topology and decoder network topology may involve the use of trained layers, such as convolutions, in which case weights are also needed. The encoder network topology and decoder network topology form a ‘bottleneck’ between the first network portion (i.e., the CNN backbone 114) and the second network portion (i.e., the CNN head 150), with the interface between the encoder network topology and the decoder network topology forming the ‘narrowest’ part of the bottleneck and thus the lowest bitrate when compressed in the form of packed video frames. Different mechanisms (encoder network topologies and corresponding decoder network topologies) may be selected, signalled, and activated dynamically to adapt the bitrate of the bitstream 121 to network conditions or to adjust to meet application requirements for quality. Mechanisms providing higher quality generally have larger dimensions of the compressed tensors and hence require a larger packed frame area, resulting in a higher bitrate for the bitstream 121. Control in the processor 205 progresses from the step 1820 to an instantiate tensor compressor step 1815.

At the step 1815, the source device 110, under execution of the processor 205, obtains a tensor structural description 522 from a tensor codec repository 514 based on the selected tensor decompressor 512, and instantiates the tensor structural description 522 into a form suitable for execution as a tensor compressor 530. The instantiating step 1815 may involve declaring required memory and initialising data structures in the memory 205 associated with the tensor structural description 522 or allocating resources in a reconfigurable hardware device such as a field programmable gate array (FPGA). Operations defined in the tensor structural description 522 may be converted to a form more amenable for execution by the processor 205 as part of the instantiation step. Just-in-time compilation is one approach for obtaining a representation such as a ‘byte code’ that may be executed more rapidly by the processor 205 than interpreting the tensor structural description 522 directly to perform each tensor compression operation. Where the instantiated tensor compressor 530 contains trainable elements, such as convolutions, a tensor weight repository 518 is accessed to obtain necessary weights 524 for use by the trainable elements, with the weights selected based on the weight selection 516. The tensor codec repository 514 and the tensor weight repository 518 may be populated from the tensor codec repository 180. Control in the processor 205 progresses from the step 1815 to a signal tensor decompressor step 1820.

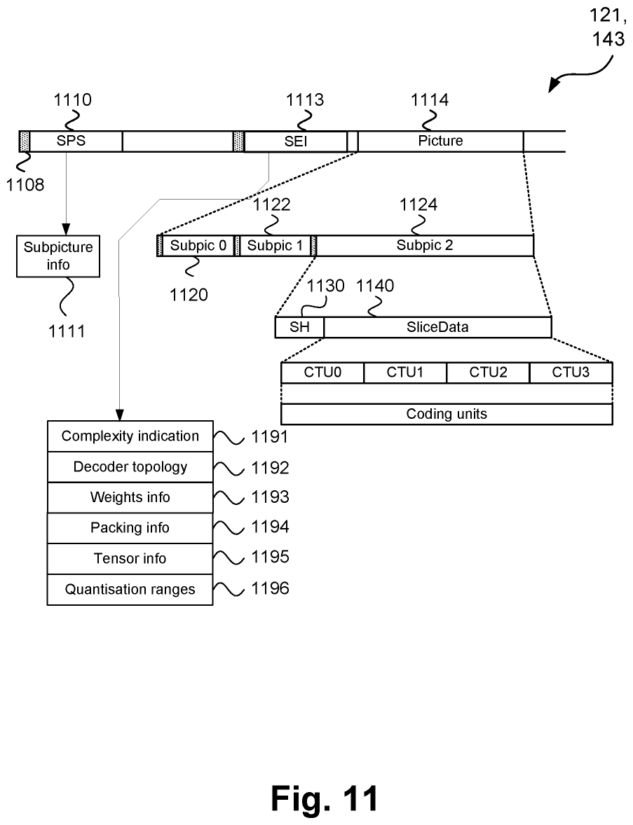

At the step 1820, a metadata encoder 544, under execution of the processor 205, encodes the selected tensor decompressor 520 into the bitstream 121 as a decoder network topology 1192 in a supplementary enhancement information (SEI) message 1113, which will be described with reference to FIG. 11 and Appendix A. The selected tensor decompressor 520 may be signalled in accordance with an ‘FCVCM decoder info SEI message’ syntax as described with reference to Appendix A. The selected tensor decompressor 520 may be signalled as an explicit network topology, using a textual representation (or syntax) such as Open Neural Network Exchange (‘ONNX’) format or Neural Network Exchange Format (‘NNEX’), from the Khronos Group, or even as a short code fragment such as a Pytorch function. Compression of such textual representations using techniques such as the ‘DEFLATE’ or ‘LZMA’ algorithm may be applied to reduce the overhead of the metadata when stored in the bitstream 121. As such, the network topology is signalled in compressed form, using a syntax as described above. The network topology specifies operations to be performed in the destination device 140 to convert tensors from a compressed representation to their original number and dimensionality, such that the uncompressed tensors may be supplied to the CNN head 149. The network weights may also be signalled in the SEI message using a format such as ISO/IEC 15938-17 “Compression of Neural Networks for Multimedia Description and Analysis”. When signalling a given network topology, the topology may be registered with the destination device 140 for reference and activation in subsequent bitstreams, avoiding the need to signal the network topology with every bitstream. In one arrangement, the system 100 may provide predetermined network topologies that do not need to be explicitly signalled in the bitstream. Predetermined network topologies may be activated in the destination device 140 via a reference to an identifier. Predetermined network topologies may be made available to the destination device 140 via external means, such as downloaded from a repository or registry of network topologies. Repositories or registries of network topologies may be accessible publicly or may be accessible within some private scope, for example, obtained via a private network or a secure network (e.g., VPN) available to instances of the destination device 140 but not the general public. Where the destination device 140 is known to have access (either already registered or available for download from an external server) to the desired network topology, the source device 110 may encode the reference to identify and activate the specific network topology required to be used when decoding the bitstream 121. Control in the processor 205 progresses from the step 1820 to a determine complexity indication step 1830.

At the step 1830, the source device 110, under execution of the processor 205, determines an indication representative of a worst-case complexity for any decoder network topology that could be signalled for the bitstream 121. Where the source device 110 may select one topology from multiple possible decoder network topologies at the step 1810 it is desirable for the destination device 140 to know, at the beginning of decoding the bitstream 121, whether the destination device 140 will be able to decode the entirety of the bitstream. The first signalled decoder network topology in the bitstream 121 may not be the most complex topology used for decoding that bitstream 121. For example, the system 100 may commence operation in a low bitrate mode, later increasing bitrate (and required decoder network topology) based on some criteria. Aspects of decoder network complexity include the number of multiply-and-accumulate (MAC) operations and the number of weights required to execute the decoder network topology. The decoder network complexity indication is configured to indicate the highest complexity of all possible decoder network topologies that the source device 110 may instruct the destination device 140 to perform. The decoder network complexity indication may be based on a decoded capability indication. In one arrangement, the decoder network complexity indication may be a scalar value mapped onto each aspect of the network complexity. For example, the network complexity indication may be a scalar value that relates to aspects such as MAC count and weight count by reference to look-up tables, with the network complexity indication set to accommodate the worst-case aspect of each aspect of the set of decompressors determined at the step 1805. Control in the processor 205 progresses from the step 1830 to an encode complexity indication step 1840.

At the step 1840, the metadata encoder 544, under execution of the processor 205, encodes the determined network complexity indication into the bitstream 121 as level information 1192 in the SEI message 1113, described with reference to FIG. 11 and Appendix A. The determined network complexity indication may be encoded as a single fixed length codeword or may be in the form of multiple values, each one corresponding to a different aspect of complexity, such as one indication for maximum MAC count and another for maximum weight memory requirement. Control in the processor 205 progresses from the step 1840 to a perform neural network first portion step 1850.

At the step 1850, the CNN backbone 114, under execution of the processor 205, performs the first portion of a neural network using frame data 113 from the video source 112 as input. Control in the processor 205 progresses from the step 1850 to a perform tensor compression step 1860.

At the step 1860, the tensor compressor 530, under execution of the processor 205, compresses the tensors 115 to produce compressed tensors 532. The compressed tensors 532 are fewer in number than the tensors 115 and reduced in dimensionality (i.e., reduced in either or both of channel count and feature map width and height). The tensor compressor 530 may implement the instantiated tensor compressor 512 in the form of precompiled ‘byte code’ or machine code or other form more amenable to direct execution by the processor 205, including by an inferencing engine as part of or associated with the processor 205, such as a graphics processing unit (GPU). Control in the processor 205 progresses from the step 1860 to an encode packing format step 1870.

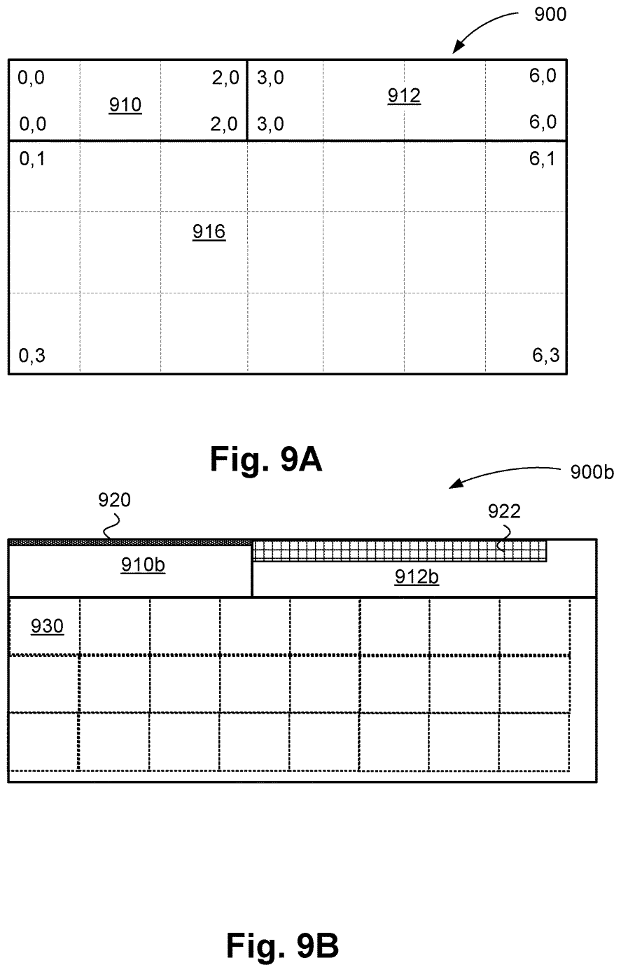

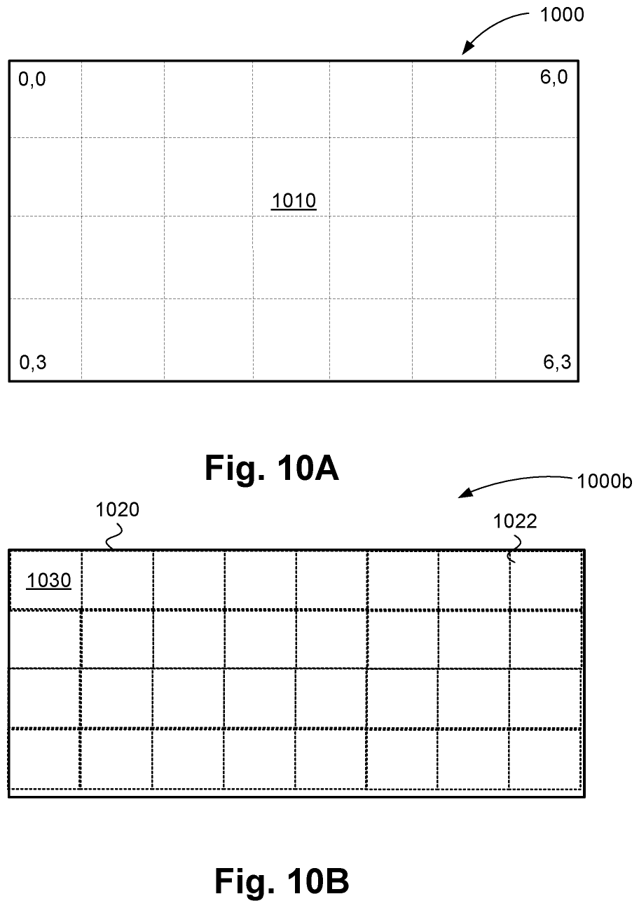

At the step 1870, the metadata encoder 544 encodes tensor information 1195 specifying the dimensionality of the compressed tensors 532 and the placement of feature maps as packing information 1194 for each tensor among the compressed tensors 532 into a video frame 540. The packing information 1194 and the tensor information 1195 are described with reference to FIG. 11 and Appendix A. The tensor information 1195 includes, for each tensor, a maximum channel count and a used channel count. The frame area for a region must be sufficient for the tensors within the region to be packed up to the maximum channel count, i.e., the maximum number of feature maps. The maximum channel count must not be altered for frames in the bitstream 121 associated with the same SPS 1110. The encoder network topology may produce fewer feature maps than the maximum and the used channel count signals the actual number of channels used, which may vary from frame to frame. The video frame 540 may be divided into regions, such as rectangular regions, with each region being used to hold feature maps from one or more tensors among the compressed tensors 532. In one arrangement, the method 1800 performs the step of determining required types of the feature maps (e.g., DC, coefficient, basis vector, MSFC) for subsequent input to the tensor decoder 146, at step 1870. The allocation of the determined types of feature maps for placement into the video frame 540 may also be determined at step 1870, where the allocation specifies one or more tensors for each subpicture of the video frame 540. Such ‘packing format’ information is described with reference to FIGS. 9A & 9B and FIGS. 10A & 10B. Control in the processor 205 progresses from the step 1870 to a quantise tensors step 1880.

At the step 1880, a quantiser module 534, under execution of the processor 205, quantises floating-point values in each tensor of the compressed tensors 532 to produce quantised compressed tensors 536. The quantised compressed tensors 536 have integer values and occupy a range within the sample range as defined by the operational bit depth of a video encoder 542. For example, when encoding video using 10-bit samples, integer values in the interval [0, 1023] are permitted. For each tensor, the minimum and maximum floating-point values form a quantisation range 526. Control in the processor 205 progresses from the step 1880 to an encode quantisation range step 1890.

At the step 1890, the metadata encoder 544, under execution of the processor 205, encodes the quantisation range 526 as a quantisation range 1196 for each tensor of the compressed tensors 532 into the bitstream 121. Quantisation ranges are used in the bitstream 121 to enable inverse quantisation to the correct range by the destination device 140. Control in the processor 205 progresses from the step 1890 to a pack tensors step 18100.

At the step 18100 a packer module 538, under execution of the processor 205, packs feature maps of each tensor of the compressed quantised tensors 536 into the video frame 540. Feature maps of a tensor are generally packed in left-to-right then top-to-bottom manner into a region in the video frame 540 to which the tensor is assigned. Although regions are defined in the SEI message 1113, regions may correspond to a ‘coding-layer’ (i.e., below metadata such as the SEI message 1113) structure such as a subpicture, slice, or tile. Coding-level structure of the frame may not be accessible outside of the decoder 800, and may differ between compression standard used such as VVC, HEVC, or AV-1. Separate signalling of the regions in the SEI message 1113 removes any dependency on specific feature at the coding layer. Each region needs to be of sufficient size to hold all the feature maps of the tensors to be packed into the respective region. Examples of region-based packing formats are described with reference to FIGS. 9A & 9B and FIGS. 10A & 10B. Control in the processor 205 progresses from the step 18100 to an encode frame step 18110.

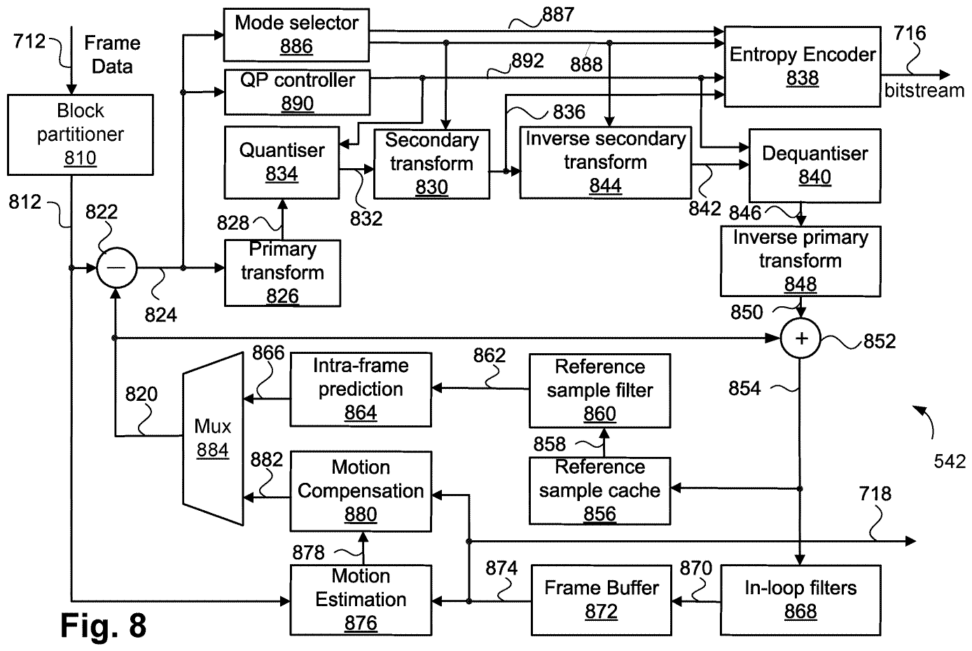

At the step 18110, a video encoder 542, under execution of the processor 205, compresses the video frame 540 to produce a coded layer portion of the bitstream 121. Operation of the video encoder 542 is described with reference to FIG. 8. The method 1800 terminates and processing progresses to the next instance of the source data 113 (e.g., the next frame from the video source 112).

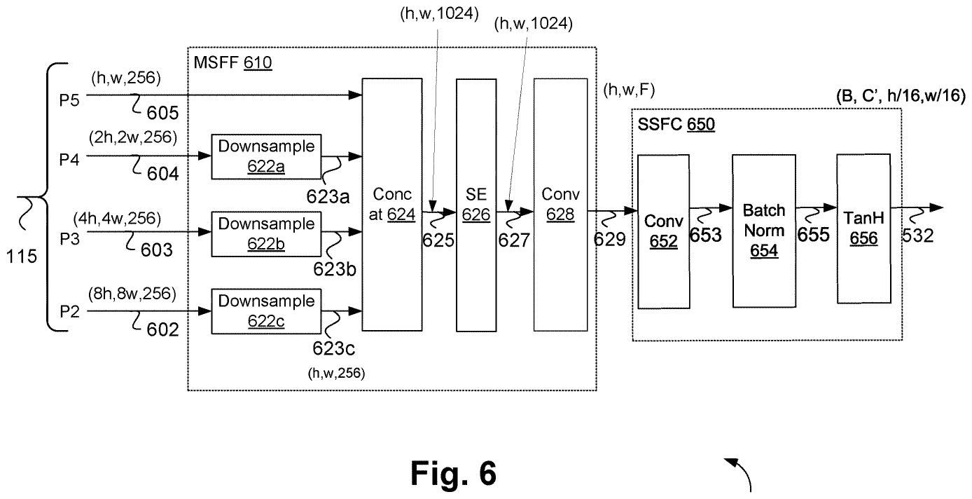

FIG. 6 is a schematic block diagram 600 showing one type of multi-scale feature fusion (MSFF) module 600, which may serve as the tensor compressor 530. The MSFF module 600 takes the intermediate tensors 113 and produces a compressed tensor 115, having reduced dimensionality compared to the intermediate tensors 113 and thus resulting in a reduction in bitrate when encoded as part of a packed frame. The MSFF module 600 uses trained network layers and requires a corresponding module in the tensor decoder 146 to restore tensor dimensionality so the tensors 149 may be supplied to the CNN head 150. The MSFC module 600 takes four tensors as input and requires each one the tensors to have two-hundred and fixty-six (256) channels, so that the MSFF module 600 is compatible with the P-layers of the FasterRCNN or MaskRCNN networks. However, variants of the MSFF module 600 compatible with different numbers of layers and different channel counts are possible.

The MSFF module 600 produces one tensor as output with sixty-four (64) channels and a feature map size corresponding to the P5 layer seen at the input, however variants with different channel count are also possible. Each variant of the MSFF module 600 requires different weights to be used for proper operation. Where several variants of the MSFF module 600 are able to be used in the system 100 for a given network, the packing format may be set to a worst-case feature map count of the compressed tensors of the currently used decoder network topology, and the actual used channel count may be updated at runtime as part of the tensor information 1195.

The MSFC module 600 includes an MSFF block 610 shown in FIG. 6, which produces a single tensor from the plurality of tensors 115 using one or more downsampling filters. The MSFF block 610, under execution of the processor 205, combines each tensor of a first set of tensors (i.e., 602, 603, 604, 605), to produce the combined tensor 629. The combined tensor 629 forms a representation of the FPN layer tensors. Downsample modules 622a, 622b, and 622c operate on the tensors having larger spatial scale, i.e., P4 604 at (2h, 2w, 256), and P3 603 at (4h, 4w, 256), and P2 602 at (8h, 8w, 256), respectively. Modules 622a, 622b, and 622c perform downsampling to match the spatial scale of the smallest tensor, i.e., P5 605 at (h, w, 256), producing downscaled P5 tensors 623a, 623b, 623c, respectively. A concatenation module 624 performs a channel-wise concatenation of the tensors 605, 623a, 623b, and 623c to produce concatenated tensor 625, of dimensions (h, w, 1024). The concatenated tensor 625 is passed to a squeeze and excitation (SE) module 626 to produce a tensor 627. The SE module 626 sequentially performs a global pooling, a fully-connected layer with reduction in channel count, a rectified linear unit activation unit, a second fully-connected layer restoring the channel count, and a sigmoid activation function to produce a scaling tensor. The tensor 625 is scaled according to the scaling tensor to produce the output as the tensor 627. The SE block 626 is capable of being trained to adaptively alter the weighting of different channels in the tensor passed through, based on the first fully-connected layer output.

The first fully-connected layer output reduces each feature map for each channel to a single value. Each single value is passed through a non-linear activation unit (ReLU) to create a conditional representation of the single value, suitable for weighting of other channels, with restoration to the full channel count performed by the second fully-connected layer. The SE block 626 is thus capable of extracting non-linear inter-channel correlation in producing the tensor 627 from the tensor 625, to a greater extent than is possible purely with convolutional (linear) layers. The tensor 627 is passed to a convolutional layer 628. The convolutional layer 628 implements one or more convolutional layers to produce the combined tensor 629, with channel count reduced to F channels, typically 256 channels (i.e., F=256). Further reduction in the channel count is achieved by a single-scale feature compression (SSFC) module 650.

The SSFC module 650 receives the tensor 629 and applies a convolution 652 to reduce the channel count from F (256) down to C′ (nominally set to 64 channels) to produce tensor 653. The tensor 653 is then passed to a batch normalisation module 654 to produce batch normalised tensor 655, which is passed to a hyperbolic tangent activation layer 656 to produce compressed tensor 532. The output of the MSFC module 600 is a one tensor per frame with a fixed feature map size and fixed channel count.

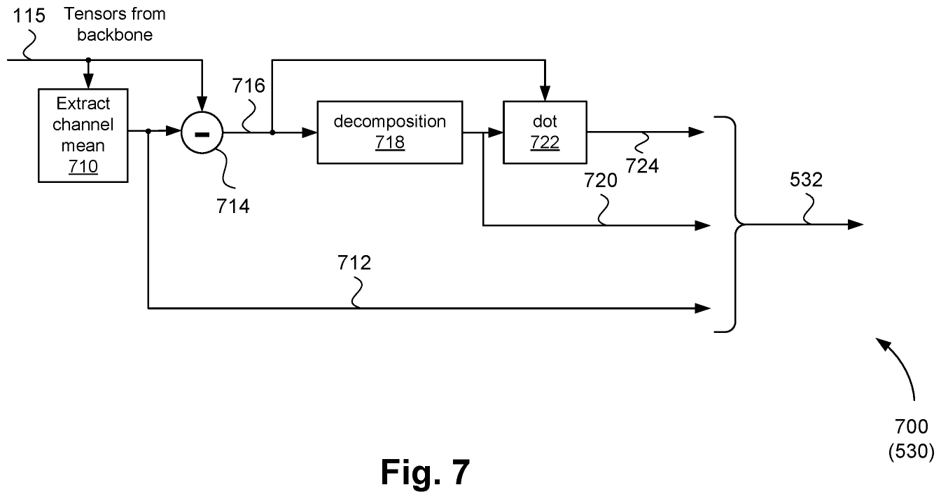

FIG. 7 is a schematic block diagram showing an inter-channel decorrelation-based tensor compressor 700, which may serve as the tensor compressor 530. The tensor compressor 700 operates without need for any trained layers and relies upon extracting inter-channel redundancy at runtime (i.e., using the incoming tensor data from the CNN backbone 114 rather than relying upon pretrained weights). The tensor compressor 700 outputs three types of data: mean, basis vectors, and coefficients. The tensor compressor 700 compresses one tensor and multiple instances of the tensor compressor 700 may be instantiated as the tensor compressor 530 to compress multiple tensors. When multiple instances of the tensor compressor 700 are instantiated, tensors of the same type from each instance may be packed into the same region. For example, basis vectors from each instance may be packed into a single region. These types of data are held in tensors and packed into three separate regions within a frame. The number of basis vectors to be used may be varied during the course of processing frames and the number of coefficients used may also be varied, although the number of coefficients must not exceed the number of basis vectors. As such, dimensionality of the basis vectors and/or coefficients may be updated from time to time to signal to the decoder the contents of a decoded packed frame. As seen in FIG. 7, an extract channel mean module 710, under execution of the processor 205, performs an average operation on a tensor of the tensors 115 across the spatial dimensions (i.e., width and height) to produce a per-channel mean 712 as a 1D tensor of C (channel count of a tensor of the tensors 115). The extract channel mean module 710 may operate less frequently than on each received tensors 115, in which case the channel mean 712 is updated only on specific frames. The packed frames containing an updated channel mean 712 may be indicated via a nonzero channel count for the tensor 712 via the tensor information 1195 or via a separate tensor update flag included in the SEI message 1113.

For each channel in a tensor of the tensors 115, a DC shift is performed by a subtraction module 714 that subtracts a value, constant for the feature map and obtained from the mean channel 712, from each spatial location in the feature map. The subtracted value is a respective value in the mean reconstructed channel 716. As a result of the subtraction module 714, a zero-centred tensor 716 is output with DC component found within each feature map removed from the respective feature map.

A decomposition module 718, under execution of the processor 205, operates to produce a set of basis vectors 720 for a tensor of the tensors 115. The decomposition module 718 receives the zero-centred tensor 716 as an input and generates a set of basis vectors 720 by performing a principal component analysis (PCA) method, such as singular value decomposition (SVD) or the like. One basis vector maps all channels onto a single value using a dot product operation, so with two-hundred and fifty-six (256) channels in a tensor of the tensors 115, one basis vector has dimensions 256×1. If the decomposition module 718 produces the first N basis vectors, such as twenty-five (25), the result basis vectors have dimensions 256×N or 256×25. Basis vectors are relative to the origin point and so the zero-mean tensor 712 is used to ensure an orthonormal basis can be found. Each basis vector is a vector relating all the channels to a reduced set of channels. As such, the basis vectors collectively enable representing tensor data spanning all channels into a smaller set of basis vectors. Each basis vector is derived with all samples in each feature map for a given channel being considered. The vectors 720 contain fewer basis vectors than there are channels in a tensor of the tensors 115, corresponding to a reduction in the dimensionality of a tensor of the tensors 115. The basis vectors 720 represent a tensor of the tensors 115 in a subspace that accounts for, or ‘explains’, the maximum amount of variance in a tensor of the tensors 115 for the number of components in the basis vectors 720. Basis vectors are ordered from the vector with the greatest explained variance down to the vector with the least explained variance. In other words, the basis vectors 720 enable representation of a tensor of the tensors 115 with minimal degradation in quality for a given number of components, with the components being the first N ranked basis vectors.

As seen in FIG. 7, a dot product module 722, under execution of the processor 205, performs a dot product of each channel in the tensor 716 against each basis vector 720 to produce a coefficients tensor 724. The coefficients form a tensor 724 having the same width and height as a tensor of the tensors 115 but a channel count corresponding, at most, to the number of components (or basis vectors) produced by the decomposition module 718, which is fewer than the number of channels in a tensor of the tensors 115. The tensor compressor 700 may vary the number of channels in the coefficients tensor 716 for a given frame. The number of channels present in the coefficients tensor 716 for a given frame is included in the tensor information 1195, coded in an instance of the SEI message 1113 associated with the given frame. Each value in the coefficients tensor 724 represents the contribution of each basis vector in reproducing each value in each feature map.

FIG. 8 is a schematic block diagram showing functional modules of the video encoder 542. The video encoder 542 may be implemented using a general-purpose computer system 200, as shown in FIGS. 2A and 2B, where the various functional modules may be implemented by dedicated hardware within the computer system 200, by software executable within the computer system 200 such as one or more software code modules of the software application program 233 resident on the hard disk drive 205 and being controlled in its execution by the processor 205. Alternatively, the video encoder 542 may be implemented by a combination of dedicated hardware and software executable within the computer system 200. The video encoder 542 and the described methods may alternatively be implemented in dedicated hardware, such as one or more integrated circuits performing the functions or sub functions of the described methods. Such dedicated hardware may include graphic processing units (GPUs), digital signal processors (DSPs), application-specific standard products (ASSPs), application-specific integrated circuits (ASICs), FPGAs or one or more microprocessors and associated memories. In particular, the video encoder 542 comprises modules 810-890 which may each be implemented as one or more software code modules of the software application program 233.

Although the video encoder 542 of FIG. 8 is an example of a versatile video coding (VVC) video encoder, other video codecs may also be used to perform the processing stages described herein. For example, HEVC may be used. The examples described generate a bitstream of encoded data. If other codecs were used, some implementations may pack data into a different format such as a frame format or the like. The video encoder 800 receives frame data 712, each frame including one or more colour channels. The frame data 712 may be in any chroma format and bit depth supported by the profile in use, for example 4:0:0, 4:2:0 for the “Main 10” profile of the VVC standard, at eight (8) to ten (10) bits in sample precision.

As seen in FIG. 8, a block partitioner 810 firstly divides the frame data 712 into CTUs, generally square in shape and configured such that a particular size for the CTUs is used. The maximum enabled size of the CTUs may be 32×32, 64×64, or 128×128 luma samples for example, configured by a ‘sps_log2_ctu_size_minus5’ syntax element present in the ‘sequence parameter set’. The CTU size also provides a maximum CU size, as a CTU with no further splitting will contain one CU. The block partitioner 810 further divides each CTU into one or more CBs according to a luma coding tree and a chroma coding tree. The luma channel may also be referred to as a primary colour channel. Each chroma channel may also be referred to as a secondary colour channel. The CBs have a variety of sizes, and may include both square and non-square aspect ratios. However, in the VVC standard, CBs, Cus, Pus, and Tus always have side lengths that are powers of two. Thus, a current CB, represented as 812, is output from the block partitioner 810, progressing in accordance with an iteration over the one or more blocks of the CTU, in accordance with the luma coding tree and the chroma coding tree of the CTU.

The CTUs resulting from the first division of the frame data 712 may be scanned in raster scan order and may be grouped into one or more ‘slices’. A slice may be an ‘intra’ (or ‘I’) slice. An intra slice (I slice) indicates that every CU in the slice is intra predicted. Generally, the first picture in a coded layer video sequence (CLVS) contains only I slices, and is referred to as an ‘intra picture’. The CLVS may contain periodic intra pictures, forming ‘random access points’ (i.e., intermediate frames in a video sequence upon which decoding can commence). Alternatively, a slice may be uni- or bi-predicted (‘P’ or ‘B’ slice, respectively), indicating additional availability of uni- and bi-prediction in the slice, respectively.

The video encoder 542 encodes sequences of pictures according to a picture structure. One picture structure is ‘low delay’, in which case pictures using inter-prediction may only reference pictures occurring previously in the sequence. Low delay enables each picture to be output as soon as the picture is decoded, in addition to being stored for possible reference by a subsequent picture. Another picture structure is ‘random access’, whereby the coding order of pictures differs from the display order. Random access allows inter-predicted pictures to reference other pictures that, although decoded, have not yet been output. A degree of picture buffering is needed so the reference pictures in the future in terms of display order are present in the decoded picture buffer, resulting in a latency of multiple frames.

When a chroma format other than 4:0:0 is in use, in an I slice, the coding tree of each CTU may diverge below the 64×64 level into two separate coding trees, one for luma and another for chroma. Use of separate trees allows different block structure to exist between luma and chroma within a luma 64×64 area of a CTU. For example, a large chroma CB may be collocated with numerous smaller luma CBs and vice versa. In a P or B slice, a single coding tree of a CTU defines a block structure common to luma and chroma. The resulting blocks of the single tree may be intra predicted or inter predicted.

In addition to a division of pictures into slices, pictures may also be divided into ‘tiles’. A tile is a sequence of CTUs covering a rectangular region of a picture. CTU scanning occurs in a raster-scan manner within each tile and progresses from one tile to the next. A slice can be either an integer number of tiles, or an integer number of consecutive rows of CTUs within a given tile.

For each CTU, the video encoder 542 as seen in FIG. 8 operates in two stages. In the first stage (referred to as a ‘search’ stage), the block partitioner 810 tests various potential configurations of a coding tree. Each potential configuration of a coding tree has associated ‘candidate’ CBs. The first stage involves testing various candidate CBs to select CBs providing relatively high compression efficiency with relatively low distortion. The testing generally involves a Lagrangian optimisation whereby a candidate CB is evaluated based on a weighted combination of rate (i.e., coding cost) and distortion (i.e., error with respect to the input frame data 712). ‘Best’ candidate CBs (i.e., the CBs with the lowest evaluated rate/distortion) are selected for subsequent encoding into the bitstream portion 716. Included in evaluation of candidate CBs is an option to use a CB for a given area or to further split the area according to various splitting options and code each of the smaller resulting areas with further CBs, or split the areas even further. As a consequence, both the coding tree and the CBs themselves are selected in the search stage.

The video encoder 542 produces a prediction block (PB), indicated by an arrow 820, for each CB, for example, CB 812. The PB 820 is a prediction of the contents of the associated CB 712. A subtracter module 822 produces a difference, indicated as 824 (or ‘residual’, referring to the difference being in the spatial domain), between the PB 820 and the CB 812. The difference 824 is a block-size difference between corresponding samples in the PB 820 and the CB 812. The difference 824 is transformed, quantised and represented as a transform block (TB), indicated by an arrow 836. The PB 820 and associated TB 836 are typically chosen from one of many possible candidate CBs, for example, based on evaluated cost or distortion.

A candidate coding block (CB) is a CB resulting from one of the prediction modes available to the video encoder 542 for the associated PB and the resulting residual. When combined with the predicted PB in the video encoder 542, the TB 836 reduces the difference between a decoded CB and the original CB 812 at the expense of additional signalling in a bitstream.

Each candidate coding block (CB) (i.e., prediction block (PB) in combination with a transform block (TB)), has an associated coding cost (or ‘rate’) and an associated difference (or ‘distortion’). The distortion of the CB is typically estimated as a difference in sample values, such as a sum of absolute differences (SAD), a sum of squared differences (SSD) or a Hadamard transform applied to the differences. The estimate resulting from each candidate PB may be determined by a mode selector 886 using the difference 824 to determine a prediction mode 887. The prediction mode 887 indicates the decision to use a particular prediction mode for the current CB, for example, intra-frame prediction or inter-frame prediction. Estimation of the coding costs associated with each candidate prediction mode and corresponding residual coding may be performed at significantly lower cost than entropy coding of the residual. Accordingly, a number of candidate modes may be evaluated to determine an optimum mode in a rate-distortion sense even in a real-time video encoder.

Determining a preferred mode in terms of rate-distortion is typically achieved using a variation of Lagrangian optimisation. Lagrangian or similar optimisation processing can be employed to both select a preferred partitioning of a CTU into CBs (by the block partitioner 810) as well as the selection of a prediction mode from a plurality of possibilities. Through application of a Lagrangian optimisation process of the candidate modes in the mode selector module 886, the intra prediction mode with the lowest cost measurement is selected as a ‘best’ mode. The lowest cost mode includes a selected secondary transform index 888, which is also encoded in the bitstream 716 by the entropy encoder 838.

In the second stage of operation of the video encoder 542 (referred to as a ‘coding’ stage), an iteration over the determined coding tree(s) of each CTU is performed in the video encoder 542. For a CTU using separate trees, for each 64×64 luma region of the CTU, a luma coding tree is firstly encoded followed by a chroma coding tree. Within the luma coding tree, only luma CBs are encoded and within the chroma coding tree only chroma CBs are encoded. For a CTU using a shared tree, a single tree describes the CUS (i.e., the luma CBs and the chroma CBs) according to the common block structure of the shared tree.

The entropy encoder 838 supports bitwise coding of syntax elements using variable-length and fixed-length codewords, and an arithmetic coding mode for syntax elements. Portions of the bitstream such as ‘parameter sets’, for example, the sequence parameter set (SPS), the picture parameter set (PPS), and the picture header (PH) use a combination of fixed-length codewords and variable-length codewords. Slices, also referred to as contiguous portions, have a slice header that uses variable length coding followed by slice data, which uses arithmetic coding. The slice header defines parameters specific to the current slice, such as slice-level quantisation parameter offsets, and may include an instance of the PH. The slice data includes the syntax elements of each CTU in the slice. Use of variable length coding and arithmetic coding requires sequential parsing within each portion of the bitstream. The portions may be delineated with a start code to form ‘network abstraction layer units’ or ‘NAL units’. Arithmetic coding is supported using a context-adaptive binary arithmetic coding process.

Arithmetically coded syntax elements consist of sequences of one or more ‘bins’ Bins, like bits, have a value of ‘0’ or ‘1’. However, bins are not encoded in the bitstream portion 716 as discrete bits. Bins have an associated predicted (or ‘likely’ or ‘most probable’) value and an associated probability, known as a ‘context’. When the actual bin to be coded matches the predicted value, a ‘most probable symbol’ (MPS) is coded. Coding a most probable symbol is relatively inexpensive in terms of consumed bits in the bitstream portion 716, including costs that amount to less than one discrete bit. When the actual bin to be coded mismatches the likely value, a ‘least probable symbol’ (LPS) is coded. Coding a least probable symbol has a relatively high cost in terms of consumed bits. The bin coding techniques enable efficient coding of bins where the probability of a ‘0’ versus a ‘1’ is skewed. For a syntax element with two possible values (i.e., a ‘flag’), a single bin is adequate. For syntax elements with many possible values, a sequence of bins is needed. The convention for converting values of a syntax element into a sequence of bins is termed ‘binarisation’. Where the values ‘0’ and ‘1’ for a bin are equally (or near equally) likely, it is possible to omit use of a context and assume an equiprobable distribution. Bins with a context are termed ‘context-coded bins’ and bins omitting a context are termed ‘bypass-coded bins’. The binarization of a syntax element into one or more bins may result in a combination of context-coded and bypass-coded bins. Unlike directly coding one bit into the bitstream, a bypass-coded bin uses the arithmetic coding engine, which facilitates mixing context-coded and bypass-coded bins into syntax element binarisations.

For a given binarization, the presence of later bins in the sequence may be determined based on the value of earlier bins in the sequence, resulting in variable-length binarisations. Additionally, each bin may be associated with more than one context, with one context selected for use in coding a specific instance of the bin. The selection of a particular context may be dependent on earlier bins in the syntax element, the decoded values of neighbouring syntax elements (i.e., those from neighbouring blocks) and the like. Each time a context-coded bin is encoded, the context that was selected for that bin (if any) is updated in a manner reflective of the new bin value. As such, the binary arithmetic coding scheme is said to be adaptive.

The absence of a context for bypass-coded bins saves memory and reduces complexity, and thus bypass bins are used where the distribution of values for the particular bin is not skewed. One example of an entropy coder employing context and adaption is known in the art as CABAC (context adaptive binary arithmetic coder) and many variants of this coder have been employed in video coding.

A QP controller 890 determines a quantisation parameter 892, used to establish a quantisation step size for use by the quantiser 834 and the dequantiser 840. A larger quantisation step size results in the primary transform coefficients 828 being quantised into smaller values, reducing bitrate of the bitstream portion 716 at the expense of a reduction in the fidelity of inverse transform coefficients 846.

The entropy encoder 838 encodes the quantisation parameter 892 and, if in use for the current CB, the LFNST index 888, using a combination of context-coded and bypass-coded bins. The quantisation parameter 892 is encoded at the beginning of each slice and changes in the quantisation parameter 892 within a slice are coded using a ‘delta QP’ syntax element. The delta QP syntax element is signalled at most once in each area known as a ‘quantisation group’. The quantisation parameter 892 is applied to residual coefficients of the luma CB. An adjusted quantisation parameter is applied to the residual coefficients of collocated chroma CBs. The adjusted quantisation parameter may include mapping from the luma quantisation parameter 892 according to a mapping table and a CU-level offset, selected from a list of offsets. The secondary transform index 888 is signalled when the residual associated with the transform block includes significant residual coefficients only in those coefficient positions subject to transforming into primary coefficients by application of a secondary transform.

Residual coefficients of each TB associated with a CB are coded using a residual syntax. The residual syntax is designed to efficiently encode coefficients with low magnitudes, using mainly arithmetically coded bins to indicate significance of coefficients, along with lower-valued magnitudes and reserving bypass bins for higher magnitude residual coefficients. Accordingly, residual blocks comprising very low magnitude values and sparse placement of significant coefficients are efficiently compressed. Moreover, two residual coding schemes are present. A regular residual coding scheme is optimised for TBs with significant coefficients predominantly located in the upper-left corner of the TB, as is seen when a transform is applied. A transform-skip residual coding scheme is available for TBs where a transform is not performed and is able to efficiently encode residual coefficients regardless of their distribution throughout the TB.

A multiplexer module 884 outputs the PB 820 from an intra-frame prediction module 864 according to the determined best intra prediction mode, selected from the tested prediction mode of each candidate CB. The candidate prediction modes need not include every conceivable prediction mode supported by the video encoder 542. Intra prediction falls into three types, first, “DC intra prediction”, which involves populating a PB with a single value representing the average of nearby reconstructed samples; second, “planar intra prediction”, which involves populating a PB with samples according to a plane, with a DC offset and a vertical and horizontal gradient being derived from nearby reconstructed neighbouring samples. The nearby reconstructed samples typically include a row of reconstructed samples above the current PB, extending to the right of the PB to an extent and a column of reconstructed samples to the left of the current PB, extending downwards beyond the PB to an extent; and third, “angular intra prediction”, which involves populating a PB with reconstructed neighbouring samples filtered and propagated across the PB in a particular direction (or ‘angle’). In VVC, sixty-five (65) angles are supported, with rectangular blocks able to utilise additional angles, not available to square blocks, to produce a total of eighty-seven (87) angles.

A fourth type of intra prediction is available to chroma PBs, whereby the PB is generated from collocated luma reconstructed samples according to a ‘cross-component linear model’ (CCLM) mode. Three different CCLM modes are available, each mode using a different model derived from the neighbouring luma and chroma samples. The derived model is used to generate a block of samples for the chroma PB from the collocated luma samples. Luma blocks may be intra predicted using a matrix multiplication of the reference samples using one matrix selected from a predefined set of matrices. This matrix intra prediction (MIP) achieves gain by using matrices trained on a large set of video data, with the matrices representing relationships between reference samples and a predicted block that are not easily captured in angular, planar, or DC intra prediction modes.

The module 864 may also produce a prediction unit by copying a block from nearby the current frame using an ‘intra block copy’ (IBC) method. The location of the reference block is constrained to an area equivalent to one CTU, divided into 64×64 regions known as VPDUs, with the area covering the processed VPDUs of the current CTU and VPDUs of the previous CTU(s) within each row or CTUs and within each slice or tile up to the area limit corresponding to one 128×128 luma samples, regardless of the configured CTU size for the bitstream. This area is known as an ‘IBC virtual buffer’ and limits the IBC reference area, thus limiting the required storage. The IBC buffer is populated with reconstructed samples 854 (i.e., prior to loop filtering), and so a separate buffer to the frame buffer 872 is needed. When the CTU size is 128×128 the virtual buffer includes samples only from the CTU adjacent and to the left of the current CTU. When the CTU size is 32×32 or 64×64 the virtual buffer includes CTUs from up to the four or sixteen CTUs to the left of the current CTU. Regardless of the CTU size, access to neighbouring CTUs for obtaining samples for IBC reference blocks is constrained by boundaries such as edges of pictures, slices, or tiles. Particularly for feature maps of FPN layers having smaller dimensions, use of a CTU size such as 32×32 or 64×64 results in a reference area more aligned to cover a set of previous feature maps. Where feature map placement is ordered based on SAD, SSE or other difference metric, access to similar feature maps for IBC prediction offers coding efficient advantage.

The residual for a predicted block when encoding feature map data is different to the residual seen for natural video. Natural video is typically captured by an image sensor, or screen content, as generally seen in operating system user interfaces and the like. Feature map residuals tend to contain much detail. The level of detail in feature map residuals is amenable to transform skip coding more than predominantly low-frequency coefficients of various transforms. An intra-predicted luma coding block may be partitioned into a set of equal-sized prediction blocks, either vertically or horizontally, which each block having a minimum area of sixteen (16) luma samples.

Where previously reconstructed neighbouring samples are unavailable, for example at the edge of the frame, a default half-tone value of one half the range of the samples is used. For example, for 10-bit video a value of five-hundred and twelve (512) is used. As no previous samples are available for a CB located at the top-left position of a frame, angular and planar intra-prediction modes produce the same output as the DC prediction mode (i.e., a flat plane of samples having the half-tone value as magnitude).

For inter-frame prediction a prediction block 882 is produced using samples from one or two frames preceding the current frame in the coding order frames in the bitstream by a motion compensation module 880 and output as the PB 820 by the multiplexer module 884. Moreover, for inter-frame prediction, a single coding tree is typically used for both the luma channel and the chroma channels. The order of coding frames in the bitstream may differ from the order of the frames when captured or displayed. When one frame is used for prediction, the block is said to be ‘uni-predicted’ and has one associated motion vector. When two frames are used for prediction, the block is said to be ‘bi-predicted’ and has two associated motion vectors. For a P slice, each CU may be intra predicted or uni-predicted. For a B slice, each CU may be intra predicted, uni-predicted, or bi-predicted.

Frames are typically coded using a ‘group of pictures’ structure, enabling a temporal hierarchy of frames. Frames may be divided into multiple slices, each of which encodes a portion of the frame. A temporal hierarchy of frames allows a frame to reference a preceding and a subsequent picture in the order of displaying the frames. The images are coded in the order necessary to ensure the dependencies for decoding each frame are met. An affine inter prediction mode is available where instead of using one or two motion vectors to select and filter reference sample blocks for a prediction unit, the prediction unit is divided into multiple smaller blocks and a motion field is produced so each smaller block has a distinct motion vector. The motion field uses the motion vectors of nearby points to the prediction unit as ‘control points’. Affine prediction allows coding of motion different to translation with less need to use deeply split coding trees. A bi-prediction mode available to VVC performs a geometric blend of the two reference blocks along a selected axis, with angle and offset from the centre of the block signalled. This geometric partitioning mode (“GPM”) allows larger coding units to be used along the boundary between two objects, with the geometry of the boundary coded for the coding unit as an angle and centre offset. Motion vector differences, instead of using cartesian (x, y) offset, may be coded as a direction (up/down/left/right) and a distance, with a set of power-of-two distances supported. The motion vector predictor is obtained from a neighbouring block (‘merge mode’) as if no offset is applied. The current block will share the same motion vector as the selected neighbouring block.

The samples are selected according to a motion vector 878 and reference picture index. The motion vector 878 and reference picture index applies to all colour channels and thus inter prediction is described primarily in terms of operation upon Pus rather than PBs. The decomposition of each CTU into one or more inter-predicted blocks is described with a single coding tree. Inter prediction methods may vary in the number of motion parameters and their precision. Motion parameters typically comprise a reference frame index, indicating which reference frame(s) from lists of reference frames are to be used plus a spatial translation for each of the reference frames, but may include more frames, special frames, or complex affine parameters such as scaling and rotation. In addition, a pre-determined motion refinement process may be applied to generate dense motion estimates based on referenced sample blocks.

Having determined and selected the PB 820 and subtracted the PB 820 from the original sample block at the subtractor 822, a residual with lowest coding cost, represented as 824, is obtained and subjected to lossy compression. The lossy compression process comprises the steps of transformation, quantisation and entropy coding. A forward primary transform module 826 applies a forward transform to the difference 824, converting the difference 824 from the spatial domain to the frequency domain, and producing primary transform coefficients represented by an arrow 828. The largest primary transform size in one dimension is either a 32-point DCT-2 or a 64-point DCT-2 transform, configured by a ‘sps_max_luma_transform_size_64_flag’ in the sequence parameter set. If the CB being encoded is larger than the largest supported primary transform size expressed as a block size (e.g. 64×64 or 32×32), the primary transform 826 is applied in a tiled manner to transform all samples of the difference 824. Where a non-square CB is used, tiling is also performed using the largest available transform size in each dimension of the CB. For example, when a maximum transform size of thirty-two (32) is used, a 64×16 CB uses two 32×16 primary transforms arranged in a tiled manner. When a CB is larger in size than the maximum supported transform size, the CB is filled with TBs in a tiled manner. For example, a 128×128 CB with 64-pt transform maximum size is filled with four 64×64 TBs in a 2×2 arrangement. A 64×128 CB with a 32-pt transform maximum size is filled with eight 32×32 TBs in a 2×4 arrangement.

Application of the transform 826 results in multiple TBs for the CB. Where each application of the transform operates on a TB of the difference 824 larger than 32×32, e.g., 64×64, all resulting primary transform coefficients 828 outside of the upper-left 32×32 area of the TB are set to zero (i.e., discarded). The remaining primary transform coefficients 828 are passed to a quantiser module 834. The primary transform coefficients 828 are quantised according to a quantisation parameter 892 associated with the CB to produce primary transform coefficients 832. In addition to the quantisation parameter 892, the quantiser module 834 may also apply a ‘scaling list’ to allow non-uniform quantisation within the TB by further scaling residual coefficients according to their spatial position within the TB. The quantisation parameter 892 may differ for a luma CB versus each chroma CB. The primary transform coefficients 832 are passed to a forward secondary transform module 830 to produce transform coefficients represented by the arrow 836 by performing either a non-separable secondary transform (NSST) operation or bypassing the secondary transform. The forward primary transform 826 is typically separable, transforming a set of rows and then a set of columns of each TB. The forward primary transform module 826 uses either a type-II discrete cosine transform (DCT-2) in the horizontal and vertical directions, or bypass of the transform horizontally and vertically, or combinations of a type-VII discrete sine transform (DST-7) and a type-VIII discrete cosine transform (DCT-8) in either horizontal or vertical directions for luma TBs not exceeding 16 samples in width and height. Use of combinations of a DST-7 and DCT-8 is referred to as ‘multi transform selection set’ (MTS) in the VVC standard.

The forward secondary transform of the module 830 is generally a non-separable transform, which is only applied for the residual of intra-predicted Cus and may nonetheless also be bypassed. The forward secondary transform operates either on sixteen (16) samples (arranged as the upper-left 4×4 sub-block of the primary transform coefficients 828) or forty-eight (48) samples (arranged as three 4×4 sub-blocks in the upper-left 8×8 coefficients of the primary transform coefficients 828) to produce a set of secondary transform coefficients. The set of secondary transform coefficients may be fewer in number than the set of primary transform coefficients from which they are derived. Due to application of the secondary transform to only a set of coefficients adjacent to each other and including the DC coefficient, the secondary transform is referred to as a ‘low frequency non-separable secondary transform’ (LFNST). Such secondary transforms may be obtained through a training process and due to their non-separable nature and trained origin, exploit additional redundancy in the residual signal not able to be captured by separable transforms such as variants of DCT and DST. Moreover, when the LFNST is applied, all remaining coefficients in the TB are zero, both in the primary transform domain and the secondary transform domain.

The quantisation parameter 892 is constant for a given TB and thus results in a uniform scaling for producing residual coefficients in the primary transform domain for a TB. The quantisation parameter 892 may vary periodically with a signalled ‘delta quantisation parameter’. The delta quantisation parameter (delta QP) is signalled once for Cus contained within a given area, referred to as a ‘quantisation group’. If a CU is larger than the quantisation group size, delta QP is signalled once with one of the TBs of the CU. That is, the delta QP is signalled by the entropy encoder 838 once for the first quantisation group of the CU and not signalled for any subsequent quantisation groups of the CU. A non-uniform scaling is also possible by application of a ‘quantisation matrix’, whereby the scaling factor applied for each residual coefficient is derived from a combination of the quantisation parameter 892 and the corresponding entry in a scaling matrix. The scaling matrix may have a size that is smaller than the size of the TB, and when applied to the TB a nearest neighbour approach is used to provide scaling values for each residual coefficient from a scaling matrix smaller in size than the TB size. The residual coefficients 836 are supplied to the entropy encoder 838 for encoding in the bitstream portion 716. Typically, the residual coefficients of each TB with at least one significant residual coefficient of the TU are scanned to produce an ordered list of values, according to a scan pattern. The scan pattern generally scans the TB as a sequence of 4×4 ‘sub-blocks’, providing a regular scanning operation at the granularity of 4×4 sets of residual coefficients, with the arrangement of sub-blocks dependent on the size of the TB. The scan within each sub-block and the progression from one sub-block to the next typically follow a backward diagonal scan pattern. Additionally, the quantisation parameter 892 is encoded into the bitstream portion 716 using a delta QP syntax element, and a slice QP for the initial value in a given slice or subpicture and the secondary transform index 888 is encoded in the bitstream portion 716.

As described above, the video encoder 542 needs access to a frame representation corresponding to the decoded frame representation seen in the video decoder. Thus, the residual coefficients 836 are passed through an inverse secondary transform module 844, operating in accordance with the secondary transform index 888 to produce intermediate inverse transform coefficients, represented by an arrow 842. The intermediate inverse transform coefficients 842 are inverse quantised by the dequantiser module 840 according to the quantisation parameter 892 to produce inverse transform coefficients, represented by an arrow 846. The dequantiser module 840 may also perform an inverse non-uniform scaling of residual coefficients using a scaling list, corresponding to the forward scaling performed in the quantiser module 834. The inverse transform coefficients 846 are passed to an inverse primary transform module 848 to produce residual samples, represented by an arrow 850, of the TU. The inverse primary transform module 848 applies DCT-2 transforms horizontally and vertically, constrained by the maximum available transform size as described with reference to the forward primary transform module 826. The types of inverse transform performed by the inverse secondary transform module 844 correspond with the types of forward transform performed by the forward secondary transform module 830. The types of inverse transform performed by the inverse primary transform module 848 correspond with the types of primary transform performed by the primary transform module 826. A summation module 852 adds the residual samples 850 and the PB 820 to produce reconstructed samples (indicated by an arrow 854) of the CU.

The reconstructed samples 854 are passed to a reference sample cache 856 and an in-loop filters module 868. The reference sample cache 856, typically implemented using static RAM on an ASIC to avoid costly off-chip memory access, provides minimal sample storage needed to satisfy the dependencies for generating intra-frame PBs for subsequent Cus in the frame. The minimal dependencies typically include a ‘line buffer’ of samples along the bottom of a row of CTUs, for use by the next row of CTUs and column buffering the extent of which is set by the height of the CTU. The reference sample cache 856 supplies reference samples (represented by an arrow 858) to a reference sample filter 860. The sample filter 860 applies a smoothing operation to produce filtered reference samples (indicated by an arrow 862). The filtered reference samples 862 are used by the intra-frame prediction module 864 to produce an intra-predicted block of samples, represented by an arrow 866. For each candidate intra prediction mode the intra-frame prediction module 864 produces a block of samples, that is 866. The block of samples 866 is generated by the module 864 using techniques such as DC, planar or angular intra prediction. The block of samples 866 may also be produced using a matrix-multiplication approach with neighbouring reference sample as input and a matrix selected from a set of matrices by the video encoder 800, with the selected matrix signalled in the bitstream 716 using an index to identify which matrix of the set of matrices is to be used by the video decoder.

The in-loop filters module 868 applies several filtering stages to the reconstructed samples 854. The filtering stages include a ‘deblocking filter’ (DBF) which applies smoothing aligned to the CU boundaries to reduce artefacts resulting from discontinuities. Another filtering stage present in the in-loop filters module 768 is an ‘adaptive loop filter’ (ALF), which applies a Wiener-based adaptive filter to further reduce distortion. A further available filtering stage in the in-loop filters module 868 is a ‘sample adaptive offset’ (SAO) filter. The SAO filter operates by firstly classifying reconstructed samples into one or multiple categories and, according to the allocated category, applying an offset at the sample level.

Filtered samples, represented by an arrow 870, are output from the in-loop filters module 868. The filtered samples 870 are stored in the frame buffer 872. The frame buffer 872 typically has the capacity to store several (e.g., up to sixteen (16)) pictures and thus is stored in the memory 206. The frame buffer 872 is not typically stored using on-chip memory due to the large memory consumption required. As such, access to the frame buffer 872 is costly in terms of memory bandwidth. The frame buffer 872 provides reference frames (represented by an arrow 874) to a motion estimation module 876 and the motion compensation module 880. The reference frames 874 are output as the reconstructed frame 718 of the encoder module 542. In the example of FIG. 8, the reconstructed frame is a result of operation of lossy VVC encoding, that is due to operation of the modules 810 to 890.

The motion estimation module 876 estimates a number of ‘motion vectors’ (indicated as 878), each being a Cartesian spatial offset from the location of the present CB, referencing a block in one of the reference frames in the frame buffer 872. A filtered block of reference samples (represented as 882) is produced for each motion vector. The filtered reference samples 882 form further candidate modes available for potential selection by the mode selector 886. Moreover, for a given CU, the PU 820 may be formed using one reference block (‘uni-predicted’) or may be formed using two reference blocks (‘bi-predicted’). For the selected motion vector, the motion compensation module 880 produces the PB 820 in accordance with a filtering process supportive of sub-pixel accuracy in the motion vectors. As such, the motion estimation module 876 (which operates on many candidate motion vectors) may perform a simplified filtering process compared to that of the motion compensation module 880 (which operates on the selected candidate only) to achieve reduced computational complexity. When the video encoder 542 selects inter prediction for a CU the motion vector 878 is encoded into the bitstream portion 716.

Although the video encoder 542 of FIG. 8 is described with reference to versatile video coding (VVC), other video coding standards or implementations may also employ the processing stages of modules 810-890. The frame data 712 (and bitstream 121) may also be read from (or written to) memory 206, the hard disk drive 210, a CD-ROM, a Blu-ray disk™ or other computer readable storage medium. Additionally, the frame data 712 (and bitstream 121) may be received from (or transmitted to) an external source, such as a server connected to the communications network 220 or a radio-frequency receiver. The communications network 220 may provide limited bandwidth, necessitating the use of rate control in the video encoder 120 to avoid saturating the network at times when the frame data 712 is difficult to compress.

The bitstream 121 may be constructed from one or more slices, representing spatial sections (collections of CTUs) of the frame data 712, produced by one or more instances of the video encoder 542, each producing a bitstream portion 716 and operating in a co-ordinated manner under control of the processor 205. The bitstream portion 716 may also contain one slice that corresponds to one region to be output as a collection of subpictures forming one picture, each being independently encodable and independently decodable with respect to any of the other slices or subpictures in the picture.

FIGS. 9A & 9B are a schematic block diagrams showing a division of a picture 900 into regions 910, 912, and 916, suitable for packing data from the PCA-based encoder network topology 700. Feature maps of each tensor is packed by the packer 538. The example of FIGS. 9A and 9B shows three regions corresponding to mean channel, basis vectors, and coefficients.

Referring to FIG. 9B, the picture 900b corresponds to the picture 900, region 910b corresponds to 910 and 912b corresponds to 912. The region 910b holds mean channel data, such as the mean channel 920 for each tensor of the tensors 115. In the example of FIG. 9B the basis vectors include basis vector 922 amongst others, with the basis vectors packed into the area of the region 912b in a non-overlapping manner. The basis vectors 922 form an C×C′ array of integer-quantised values, where C is the number of channels in a tensor of the tensors 115 and C′ is the number of basis vectors resulting from the decomposition performed by the decomposition module 718. Where multiple tensors are decomposed into sets of basis vectors, such as when the tensors 115 comprise a plurality of tensors, the basis vectors 922 include each set of basis vectors arranged in a non-overlapping left-aligned vertical concatenation.

Area in the picture 900 (or 900b) that is not used to store any data may be occupied by sample values corresponding to the value ‘0’ after application of inverse quantisation to convert from sample values back to the floating-point domain. Similarly, area in regions 910 (or 910b), 912 (or 912b), 916 that is not used to store any data, may be occupied by sample values corresponding to the value ‘0’ after application of inverse quantisation to convert from sample values back to the floating-point domain. The region 916 holds coefficient corresponding to 724 of FIG. 7, with coefficient for each basis vector forming a width by height feature map. The coefficient region 916 has coefficients packed as, e.g., twenty-four feature maps (applicable to basis vectors [0 . . . 23]), such as feature map 930.

Each region (910, 912, and 916) is aligned to the CTU grid, normally 128×128. The location of each region is specified as the top-left and bottom-right cartesian CTU addresses, when addressed using cartesian co-ordinates in units of CTU size. For example, region 916 occupies CTUs from CTU at (0,1), corresponding to top-left luma sample at location (0, 128) down to the CTU at (6,3), corresponding to bottom right luma sample location at (6×128+127, 3×128+127) or (895, 511).

FIGS. 10A & 10B are schematic block diagrams showing a division of picture 1000 into one region 1010, suitable for packing the compressed tensor 532 as may be produced by the tensor compressor 600. Each feature map of the compressed tensor, such as feature map 1030, is packed in the region 1010, such that feature maps are packed in a left-to-right manner, progressing to the next row once available space on the current row has been exhausted. By virtue of the tensor compressor 600, the required area to pack the compressed tensor 532 is smaller than the required area that would be required were each tensor of the tensors 115 packed into the picture 1000. The region 1010 is defined based on top-left and bottom-right cartesian CTU addresses.

FIG. 11 is a schematic block diagram showing the bitstream 121 or 143 holding encoded packed feature maps and associated metadata. The bitstream 121 or 143 contains groups of syntax elements each prefaced by a ‘network abstraction layer’ (NAL) unit header. For example, a NAL unit header 1108 precedes a sequence parameter set (SPS) 1110. The SPS 1110 specifies the layout of the picture (e.g., the picture 900 or the picture 1000), depending on the selected compressor and decompressor at the step 1810. The layout of the picture includes the positions and sizes of any subpictures (e.g., 910, 912, and 916), using subpicture information 1111. The SPS 1110 needs to be decoded prior to decoding a sequence of frames related by prediction structure (i.e., inter-prediction reference pictures) and generally having the same width, height, bit-depth, and chroma format. In applications involving streaming, retransmissions the SPS 1110 may be performed to enable decoding to commence at an intermediate point in the bitstream. Moreover, if the decoder network topology is modified during execution the required frame area for the compressed tensors may change, necessitating insertion of another SPS to signal updated frame dimensions. The SPS 1110 also indicates the chroma format, the bit depth, the resolution of the frame data represented by the bitstream 121. A coded subpicture 1122 encoding subpicture 912, includes a slice header 1130 followed by slice data 1140. The slice data 1140 includes a sequence of CTUs, providing the coded representation of the frame data. Coded subpicture 1124 encodes subpicture 916, corresponding to the coefficients. The bitstream 121 includes an SEI message 1113, written by the metadata encoder 544 and syntactically conforming or equivalent to that syntax described in Appendix A. The SEI message 1113 encodes metadata needed to convert a decoded frame into a set of tensors suitable for use by the CNN head 150.

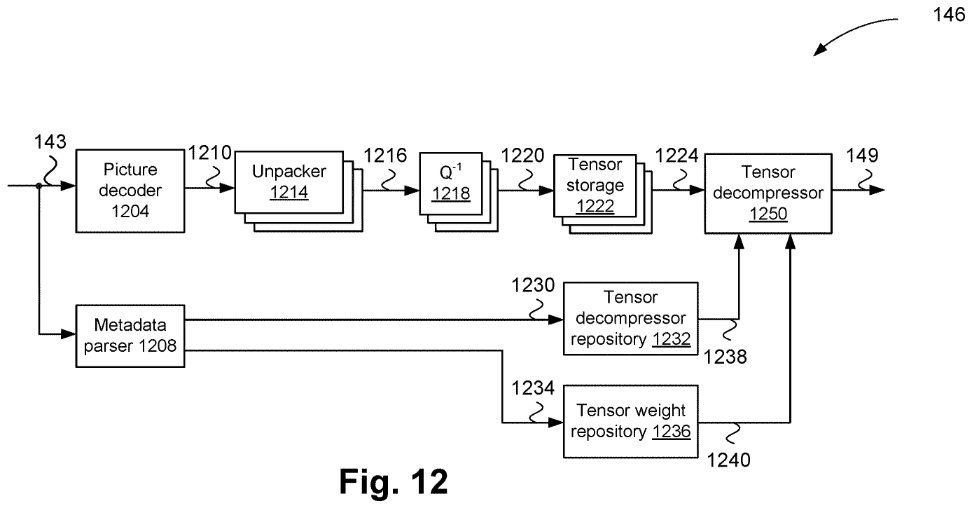

FIG. 12 is a schematic block diagram showing the tensor decoder 146 with a configurable tensor decompressor 1250. FIG. 19 shows a method 1900 for decoding a bitstream, reconstructing tensors according to an indicated tensor decompressor, and performing a second portion of the CNN. As described, the method 1900 is configured for determining a required decoder network complexity for a given decoder network topology and determining a decoder network complexity indication for a bitstream. The indication may be used to reference a predetermined decoder network topology so that the decoder network topology is decoded from the bitstream. The bitstream may be subsequently decoded using the determined decoder network topology to produce decoded tensors depending on the required network complexity and the decoder network complexity indication. The decoder network complexity may include a count of at least one of the following aspects: multiply accumulate operations, intermediate tensors values, memory access operations for tensors, and number of weights.

The tensor decoder 146 and the method 1900 may be implemented as one or more software application programs 233 executable within the computer system 200. The tensor decoder 146 and the method 1900 may be effected by instructions 231 (see FIG. 2B) in the software 233 that are carried out within the computer system 200. The software instructions 231 may be formed as one or more code modules, each for performing one or more particular tasks. The method 1900 begins at a determine tensor decompressor step 1910.

At the step 1910, the tensor decoder 146 determines a decoder network topology to be used for restoring dimensionality of compressed tensors to a dimensionality compatible for use as input to the CNN head 150. A metadata parser 1208, under execution of the processor 205, decodes the decoder topology 1192 from the SEI message 1113 as either a full decoder network topology or decodes a reference to a description of the decoder network topology, which may have been previously included in the bitstream 143 or may have been obtained via external means (e.g., downloaded from an internet connection). The decoder network topology may be encoded using formats such as ONNX, NNEX, or Pytorch code. The decoded network topology may include a format indication, signalling which format is in use. For a given format, multiple versions may be defined (or new versions may be created in future) and so a format version indicator is also included. Formats may be textual in nature and thus use of an optional compression stage, using a technique such as ZIP or LZMA, may be signalled to minimise the storage overhead of the decoder network topology in the bitstream 143.

As seen in FIG. 12, a tensor decompressor information 1230 specifies a decoder network topology either by reference or by structure. If the tensor decompressor information 1230 specifies the decoder network topology by reference, the structure of the decoder network topology is obtained from a tensor decompressor repository 1232 (if available) or the repository 1232 obtains the topology from the tensor codec repository 180. The decoder network topology may be retained in the repository 1232 for future use even after a different decoder network topology is used. The decoder network topology may be retained in the repository 1232 for future use even after a subsequent SPS (e.g., 1110) is received, indicating the commencement of a new bitstream. If the decoder network topology requires weights, weight information 1234 is provided to a tensor weights repository to specify weights either by reference or by value. Control in the processor 205 progresses from the step 1910 to a decode complexity indication step 1920.

At the step 1920, the metadata parser 1208, under execution of the processor 205, decodes one or more syntax elements indicating the worst-case complexity of any decoder network topology that will be implemented in the tensor decompressor 1250 as the complexity indication 1191 from the SEI message 1113. Worst-case complexity includes one or more of the worst case in terms of storage of intermediate tensors within the tensor decompressor 1250, worst-case number of MAC operations to be performed by the tensor decompressor 1250 and worst case floating-point operations of any kind to be performed in the tensor decompressor 1250. Control in the processor 205 progresses from the step 1920 to a determine tensor decompressor complexity step 1930.

At the step 1930, the tensor decoder 146, under execution of the processor 205, determines the required complexity to perform the determined decoder network topology. An operation count is produced by performing a traversal of the stages defined in the determined decoder network topology and counting operations implied by each stage without performing the stage. Dimensionality of any persistent tensor data (i.e., tensors retained from one invocation of the tensor decompressor 1250 to the next invocation), is recorded. The volume of intermediate tensor data is retained, such that the maximum amount of intermediate tensor data concurrently retained in the memory 206 is determined. Control in the processor 205 progresses from the step 1930 to a decode packing format step 1940.

At the step 1940, the metadata parser 1208, under execution of the processor 205, decodes the packing information 1194 and the tensor information 1195 from the SEI message 1113 in the bitstream 143 to determine the packing format. The packing format indicates a division of a frame into one or more regions, such as rectangular regions, each region being used to hold feature maps for one or more tensors. When one region is in use, generally the entire video frame is available for that region. The packing format may describe regions with a granularity of integer CTUs, with the cartesian co-ordinate of the top-left and bottom-right CTU bounding a region encoded in the bitstream 143, in units of CTU or 128 luma samples. The regions are decoded as an ordered list, addressable by index, enabling a mapping of one or more tensors to each region. The area of each region in the packing format should be sufficient to hold the maximum number of feature maps the encoder network topology can produce for the tensors contained within the respective region. When an updated decoder network topology is signalled, a new packing format needs to be signalled to specify how to unpack compressed tensors resulting from the new decoder network topology. Control in the processor 205 progresses from the step 1940 to a complexity test step 1950.

At the step 1950, the tensor decoder 146, under execution of the processor 205, compares the decoder network topology complexity determined at the step 1930 with the complexity indication decoded at the step 1920. If the determined complexity is less than or equal to the complexity indication (“OK” at step 1950) control in the processor 205 progresses from the step 1950 to an instantiate tensor decompressor step 1970, otherwise (“NOT OK” at step 1950) control in the processor 205 progresses from the step 1950 to an error condition step 1960.

At the step 1960, the tensor decoder 146 enters and error state and decoding cannot continue due to the possibility of a signalled decoder network topology exceeding the capabilities of the tensor decompressor 1250. The method 1900 terminates.

At the step 1970, the tensor decompressor 1350 is initialized in accordance with the decoder network topology as determined at the step 1910. The step 1970 is performed only when a new decoder network topology was determined at the step 1910, i.e. subsequent invocations of the method 1900 for which no new decoder network topology is determined may reuse resources allocated at the step 1970. Sufficient storage memory is allocated to hold any persistent tensors, (i.e., tensors retained from one invocation of the method 1900 to the next invocation of the method 1900), along with memory to hold the maximum concurrently used intermediate tensors in performing the decoder network topology. In the case where hardware acceleration is applied for the decoder network topology, reservation of sufficient execution units, such as MACs, DSP blocks, e.g., in an FPGA, may also take place. In the case where the decoder network topology is to be performed in software, sufficient execution time on available resources such as CPU or GPU is reserved to enable real-time operation of the method 1900 (i.e., sufficient to allow repeated invocations of the method 1900 as incoming packed frames are decoded without accumulated stalling, jitter, buffering delay). Control in the processor 205 progresses from the step 1970 to a decode packed frame step 1980.

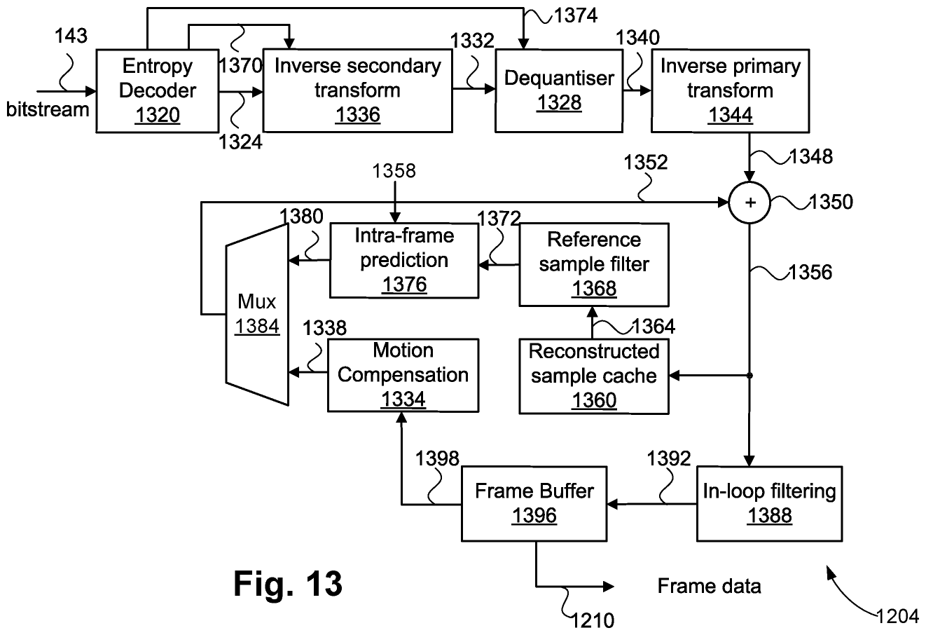

At the step 1980, the picture decoder 1204, under execution of the processor 205, decodes one packed frame from the bitstream 143 to produce a decoded frame 1210. Operation of the picture decoder 1204 is described with reference to FIG. 13. Control in the processor 205 progresses from the step 1980 to an unpack tensors step 1990.

At the step 1990, an unpacker 1214, under execution of the processor 205, reads feature maps from the decoded frame 1210 in accordance with the packing format as determined at the step 1940 and described with reference to FIGS. 9A & 9B and FIGS. 10A & 10B. For each tensor, a number of feature maps are decoded, the number corresponding to the number of used channels in the tensor as signalled in the tensor information 1195. The channels for each tensor are unpacked as two-dimensional feature maps. The number of feature maps or channels to decode for a given tensor is decoded from the bitstream 143 as a ‘channel count’. A plurality of tensors each having one channel are arranged horizontally or vertically within a slice or subpicture of the frame. The feature maps of each previously determined type are unpacked at step 1990 by the unpacker 1214 using the allocation of the feature maps determined for the frame (e.g., 1210) in the method 1800. The allocation may be decoded from an SEI message. The unpacker 1214 outputs integer tensors 1216, where the tensors 1216 have been decoded using the decoder topology for the tensor decoder 146. Control in the processor 205 progresses from the step 1990 to an inverse quantise tensors step 19100.

At the step 19100, an inverse quantiser 1218, under execution of the processor 205, performs inverse quantisation on the integer tensors 1216 to produce inverse quantised tensors 1220 by applying quantisation ranges decoded from the bitstream 143, to the determined channel count of each tensor. To perform inverse quantisation, the quantisation ranges 1196 are decoded from the SEI message 1113 by the metadata parser 1208. Control in the processor 205 progresses from the step 19100 to a buffer quantised tensors step 19110.

At the step 19110, a tensor storage module 1222, under execution of the processor 205, provides inter-frame storage of the inverse quantised tensors 1220. Of the tensors for each region of the packing format, each tensor with at least one channel or feature map decoded is stored in the tensor storage module 1222. The tensor storage module 1222 produces output tensors 1224, including the most recent tensor for each tensor where at least one feature map was decoded. In other words, where a tensor was not decoded for a current frame (i.e., a channel count of zero was determined), the most recent value for the tensor where a nonzero channel count was decoded, is used. For example, when using PCA-based methods, such as encoder network topology 700, the mean channel resulting from the mean channel module 710 may be infrequently updated, in which case the tensor storage module 1222 retains the most recent result from the mean channel module 710 for use by the tensor decompressor 1400. Control in the processor 205 progresses from the step 19110 to a perform tensor decompression step 19120.

At the step 19120, the tensor decompressor 1250, under execution of the processor 205, performs the steps specified by the decoder network topology using the tensors 1224 as input to produce decoded tensors 149. By virtue of the check performed at the step 1950, performance of the decoder network topology will not consume resources beyond those already allocated by the destination device 140 for the purpose of tensor decompression and hence will succeed in producing an output. Control in the processor 205 progresses from the step 19120 to a perform neural network second portion step 19130.

At the step 19130, the CNN head 150, under execution of the processor 205, performs the remaining layers of the neural network implemented by the system 100, using the tensors 149 as input. The method 1900 terminates and the processor 205 may reinvoke the method 1900 upon receiving the next packed frame in the bitstream 143.

FIG. 13 is a schematic block diagram showing functional modules of the video decoder 1204. The video decoder 1204 may be implemented as one or more software application programs 233 executable within the computer system 200. The video decoder 1204 may be effected by instructions 231 (see FIG. 2B) in the software 233 that are carried out within the computer system 200. The software instructions 231 may be formed as one or more code modules, each for performing one or more particular tasks.

The bitstream 143 is input to an entropy decoder module 1320. The entropy decoder module 1320 extracts syntax elements from the bitstream 143 by decoding sequences of ‘bins’ and passes the values of the syntax elements to other modules in the video decoder 1204. The entropy decoder module 1320 uses variable-length and fixed length decoding to decode SPS, PPS or slice header using an arithmetic decoding engine to decode syntax elements of the slice data as a sequence of one or more bins. Each bin may use one or more ‘contexts’, with a context describing probability levels to be used for coding a ‘one’ and a ‘zero’ value for the bin. Where multiple contexts are available for a given bin, a ‘context modelling’ or ‘context selection’ step is performed to choose one of the available contexts for decoding the bin. The process of decoding bins forms a sequential feedback loop, where each slice may be decoded in entirety by a given entropy decoder 1020 instance.

The entropy decoder module 1320 applies an arithmetic coding algorithm, for example ‘context adaptive binary arithmetic coding’ (CABAC), to decode syntax elements from the bitstream 143. The decoded syntax elements are used to reconstruct parameters within the video decoder 1204. Parameters include residual coefficients (represented by an arrow 1324), a quantisation parameter 1374, a secondary transform index 1370, and mode selection information such as an intra prediction mode (represented by an arrow 1358). The mode selection information also includes information such as motion vectors, and the partitioning of each CTU into one or more CBs. Parameters are used to generate PBs, typically in combination with sample data from previously decoded CBs.

The residual coefficients 1324 are passed to an inverse secondary transform module 1336 where either a secondary transform is applied or no operation is performed (bypass) according to a secondary transform index. The inverse secondary transform module 1336 produces reconstructed transform coefficients 1332. That is, the module 1336 produces primary transform domain coefficients from secondary transform domain coefficients. The reconstructed transform coefficients 1332 are input to a dequantiser module 1328. The dequantiser module 1328 performs inverse quantisation (or ‘scaling’) on the residual coefficients 1332, that is, in the primary transform coefficient domain, to create reconstructed intermediate transform coefficients, represented by an arrow 1340, according to the quantisation parameter 1374. The dequantiser module 1328 may also apply a scaling matrix to provide non-uniform dequantization within the TB, corresponding to operation of the dequantiser module 840. Should use of a non-uniform inverse quantisation matrix be indicated in the bitstream 143, the video decoder 1204 reads a quantisation matrix from the bitstream 143 as a sequence of scaling factors and arranges the scaling factors into a matrix. The inverse scaling uses the quantisation matrix in combination with the quantisation parameter to create the reconstructed intermediate transform coefficients 1340.

The reconstructed transform coefficients 1340 are passed to an inverse primary transform module 1344. The module 1344 transforms the coefficients 1340 from the frequency domain back to the spatial domain. The inverse primary transform module 1344 applies inverse DCT-2 transforms horizontally and vertically, constrained by the maximum available transform size as described with reference to the forward primary transform module 826. The result of operation of the module 1344 is a block of residual samples, represented by an arrow 1348. The block of residual samples 1348 is equal in size to the corresponding CB. The residual samples 1348 are supplied to a summation module 1350.

At the summation module 1350, the residual samples 1348 are added to a decoded PB (represented as 1352) to produce a block of reconstructed samples, represented by an arrow 1356. The reconstructed samples 1356 are supplied to a reconstructed sample cache 1360 and an in-loop filtering module 1388. The in-loop filtering module 1388 produces reconstructed blocks of frame samples, represented as 1392. The frame samples 1392 are written to a frame buffer 1396. The frame buffer 1396 outputs image or video frames 1210.

The reconstructed sample cache 1360 operates similarly to the reconstructed sample cache 856 of the video encoder 542. The reconstructed sample cache 1360 provides storage for reconstructed samples needed to intra predict subsequent CBs without the memory 206 (e.g., by using the data 232 instead, which is typically on-chip memory). Reference samples, represented by an arrow 1364, are obtained from the reconstructed sample cache 1360 and supplied to a reference sample filter 1368 to produce filtered reference samples indicated by arrow 1372. The filtered reference samples 1372 are supplied to an intra-frame prediction module 1376. The module 1376 produces a block of intra-predicted samples, represented by an arrow 1380, in accordance with the intra prediction mode parameter 1358 signalled in the bitstream 143 and decoded by the entropy decoder 1320. The intra prediction module 1376 supports the modes of the encoder-side module 864, including IBC and MIP. The block of samples 1380 is generated using modes such as DC, planar or angular intra prediction.

When the prediction mode of a CB is indicated to use intra prediction in the bitstream 143, the intra-predicted samples 1380 form the decoded PB 1352 via a multiplexor module 1384. Intra prediction produces a prediction block (PB) of samples, which is a block in one colour component, derived using ‘neighbouring samples’ in the same colour component. The neighbouring samples are samples adjacent to the current block and by virtue of being preceding in the block decoding order have already been reconstructed. Where luma and chroma blocks are collocated, the luma and chroma blocks may use different intra prediction modes. However, the two chroma CBs share the same intra prediction mode.

When the prediction mode of the CB is indicated to be inter prediction in the bitstream 143, a motion compensation module 1334 produces a block of inter-predicted samples, represented as 1338. The block of inter-predicted samples 1338 are produced using a motion vector, decoded from the bitstream 143 by the entropy decoder 1320, and reference frame index to select and filter a block of samples 1398 from the frame buffer 1396. The block of samples 1398 is obtained from a previously decoded frame stored in the frame buffer 1396. For bi-prediction, two blocks of samples are produced and blended together to produce samples for the decoded PB 1352. The frame buffer 1396 is populated with filtered block data 1392 from an in-loop filtering module 1388. As with the in-loop filtering module 868 of the video encoder 542, the in-loop filtering module 1388 applies any of the DBF, the ALF and SAO filtering operations. Generally, the motion vector is applied to both the luma and chroma channels, although the filtering processes for sub-sample interpolation in the luma and chroma channel are different.

FIG. 14 is a schematic block diagram showing an implementation of the inter-channel decorrelation-based tensor decoder 1400, which may serve as the tensor decompressor 1250. When multiple tensors are to be decompressed, multiple instances of the tensor decoder 1400 may be instantiated as the tensor decompressor 1250. Tensors 1224 are received from the tensor storage 1222A and include a coefficients tensor 1414, a basis vectors tensor 1412, and a channel mean tensor 1410. A zero-centred tensor 1422 is produced by a dot product module 1420, under execution of the processor 205, by performing a dot product on the coefficients 1414 and the basis vectors 1412. A summation module 1424 adds the zero-centred tensor 1422 with the mean channel 1410 to produce a tensor of the reconstructed tensors 149 as output from the tensor decoder 1400. When one type of input, such as the mean, is not required to be updated, the channel count of that type of input may be set to zero. When the channel count of an input is set to zero, the most recently received value for that input may be used instead.

FIG. 15 is a schematic block diagram showing a tensor decompressor 1500 using a multi-scale feature reconstruction stage, which may be selected at the step 1810 for use as the tensor decompressor 1250. The tensor decompressor 1500 includes a single-scale feature compression (SSFC) decompressor 1510. The SSFC decompressor 1510 receives the tensor 149 having a reduced channel count, such as 64 channels, and passes the tensor 149 to a convolution layer 1512, which outputs a tensor 1513 having a restored channel count, such as 256 channels. The tensor 1513 is passed to a batch normalisation module 1514 to produce a tensor 1515. The tensor 1515 is passed to a PreLU module 1516 to produce a tensor 1520. The tensor decompressor 1500 includes a MSFR module 1530. The MSFR module operates to produce a plurality of tensors from the tensor 1520 produced by execution of step 19100, described with reference to FIG. 19, using one or more trained convolutional layers. Upsample modules 1532, 1534, and 1536 upsample the tensor 1520 horizontally and vertically by factors of two, four, and eight, respectively, to produce tensors 1533, 1535, and 1537. The tensor 1537 forms one (P′2, 1557) output from the MSFR module 1530 and is passed to a downsample module 1542. The downsample module 1542 downsamples the tensor 1537 by a factor of two horizontally and vertically to produce a tensor 1543 having the same dimensionality as the tensor 1535. The tensor 1543 is provided to a convolution layer 1548 which outputs a tensor 1549. A summation module 1554 adds the tensors 1535 and 1549 to produce the tensor 1555 as an output (P′3) of the MSFR module 1530.

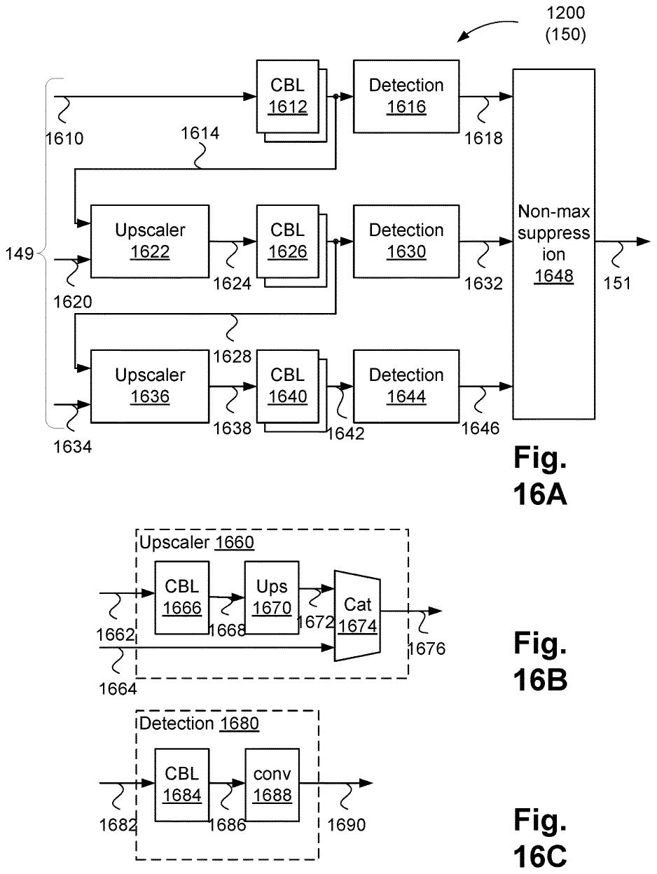

FIG. 16A is a schematic block diagram showing an example implementation 1600 of the head portion 150 of a CNN for object detection, corresponding to a portion of a “YOLOv3” network excluding the “DarkNet-53” backbone portion. The CNN head portion 150 of FIG. 16A can be used when the CNN backbone is implemented as in FIG. 3A for example. Depending on the task to be performed in the destination device 140, different networks may be substituted for the CNN head portion 150. Incoming tensors 149 are separated into the tensor of each layer (i.e., tensors 1610, 1620, and 1634). The tensor 1610 is passed to a CBL module 1612 to produce tensor 1614. The tensor 1614 is passed to a detection module 1616 and an upscaler module 1622. The detection module outputs bounding boxes 1618, in the form of a detection tensor. The bounding boxes 1618 are passed to a non-maximum suppression (NMS) module 1648.

To produce bounding boxes addressing co-ordinates in the original video data 113, prior to resizing for the backbone portion of the network 114, scaling by the original video width and height is performed at the upscaler module 1622. The upscaler module 1622 receives the tensor 1614 and the tensor 1620 and produces an upscaled tensor 1624, which is passed to a CBL module 1626. The CBL module 1626 produces a tensor 1628 as output. The tensor 1628 is passed to a detection module 1630 and an upscaler module 1636. The detection module 1630 produces a detection tensor 1632, which is supplied to the NMS module 1648. The upscaler module 1636 is another instance of the module 1622. The upscaler module 1636 receives the tensor 1628 and the tensor 1634 and outputs an upscaled tensor 1638. The upscaled tensor 1638 is passed to a CBL module 1640, which outputs a tensor 1642 to a detection module 1644. The detection module 1644 produces a detection tensor 1646, which is supplied to the NMS module 1648.

The CBL modules 1612, 1626, and 1640 each contain a concatenation of five CBL modules (e.g., CBL model 360 shown in FIG. 3D). The upscaler modules 1622 and 1636 are each instances of an upscaler module 1660 as shown in FIG. 16B. The module 1648 receives the tensors 1618, 1632 and 1646 and outputs the task result 151.

As shown in FIG. 16B, the upscaler module 1660 accepts a tensor 1662 (for example the tensor 1614 of FIG. 16A) as an input. The tensor 1662 is passed to a CBL module 1666 (having structure of the module 360) to produce a tensor 1668. The tensor 1668 is passed to an upsampler 1670 to produce an upsampled tensor 1672. A concatenation module 1674 produces a tensor 1676 by concatenating the upsampled tensor 1672 with a second input tensor 1664 (for example the tensor 1620 input to the upscaler 1622 in FIG. 16A).

The detection modules 1616, 1630, and 1644 are instances of a detection module 1680 as shown in FIG. 16C. The detection module 1680 receives a tensor 1682. The tensor 1682 is input to a CBL module 1684 having structure of the module 360. The CBL module 1684 generates a tensor 1686. The tensor 1686 is passed to a convolution module 1688, which implements a detection kernel. In some arrangements, the detection kernel applies a 1×1 kernel to produce the output on feature maps at each of the three layers of the tensor. The detection kernel is 1×1× (B× (5+C)), where B is the number of bounding boxes a particular cell can predict, typically three (3), and C is the number of classes, which may be eighty (80), resulting in a kernel size of two-hundred and fifty five (255) detection attributes (i.e. tensor 1290). The constant “5” represents four boundary box attributes (box centre x, y and size scale x, y) and one object confidence level (“objectness”). The result of a detection kernel has the same spatial dimensions as the input feature map, but the depth of the output corresponds to the detection attributes. The detection kernel is applied at each layer, typically three layers, resulting in a large number of candidate bounding boxes. A process of non-maximum suppression is applied by the NMS module 1648 to the resulting bounding boxes to discard redundant boxes, such as overlapping predictions at similar scale, resulting in a final set of bounding boxes as output for object detection.

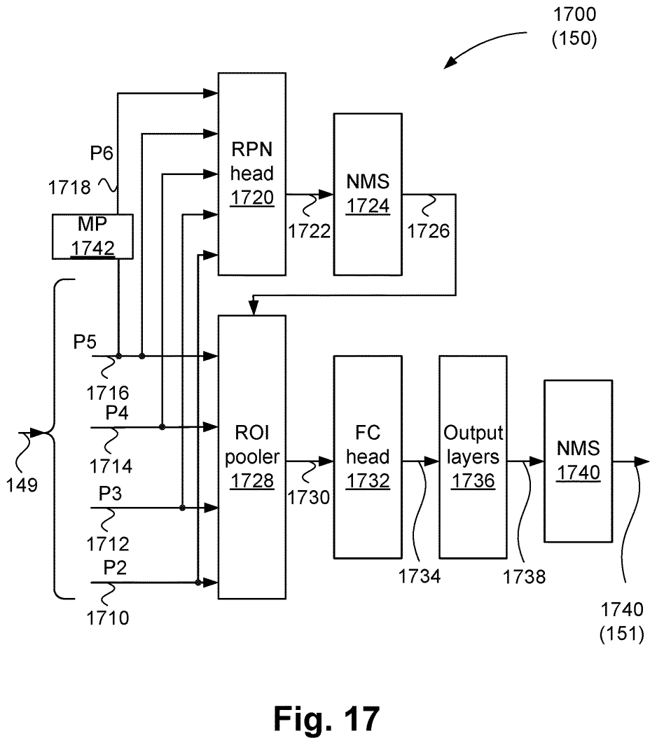

FIG. 17 is a schematic block diagram showing a head portion 1700 of a CNN. The head portion 1700 can be implemented as the CNN head portion 150 where the CNN backbone 114 is implemented as the backbone 400 for example. The head portion 1700 forms part of an overall network known as ‘Faster RCNN’ and includes a feature network (i.e., backbone portion 400), a region proposal network, and a detection network. Input to the head portion 1700 are the tensors 149, which include the P2-P6 layer tensors 1710, 1712, 1714, 1716, and 1718. The P2-P5 layer tensors 1710, 1712, 1714, and 1716, correspond to the P2 to P5 outputs 477, 475, 473, and 471 of FIG. 4. The P2-P6 tensors 1710, 1712, 1714, 1716, and 1718 are input to a region proposal network (RPN) head module 1720. The P6 tensor 1718 is produced by max pool module 1742, operating on P5 tensor 1716 to perform a 2×2 max pooling operation. The RPN head module 1720 performs a convolution on the input tensors, generating an intermediate tensor. The intermediate tensor is fed into two subsequent sibling layers, (i) one for classifications and (ii) one for bounding box, or ‘region of interest’ (ROI), regression. A resultant output is classification and bounding boxes 1722. The classification and bounding boxes 1722 are passed to an NMS module 1724. The NMS module 1724 prunes out redundant bounding boxes by removing overlapping boxes with a lower score to produce pruned bounding boxes 1726. The bounding boxes 1726 are input to a region of interest (ROI) pooler 1728. The ROI pooler 1728 uses some of the layer tensors of the tensor 149 (described further hereafter) and the bounding boxes 1726 to produce fixed-size feature maps from various input size maps using max pooling operations. In the max pooling operation a subsampling takes the maximum value in each group of input values to produce one output value in the output tensor.

Input to the ROI pooler 1728 are the P2-P5 feature maps 1710, 1712, 1714, and 1716, and region of interest proposals 1726. Each proposal (ROI) from 1726 is associated with a portion of the feature maps (1710-1716) to produce a fixed-size map. The fixed-size map is of a size independent of the underlying portion of the feature map 1710-1716. One of the feature maps 1710-1716 is selected such that the resulting cropped map has sufficient detail, for example, according to the following rule: floor (4+log 2(sqrt (box_area)/224)), where 224 is the canonical box size. The ROI pooler 1728 operates to crop incoming feature maps according to the proposals 1726 producing a tensor 1730.

The tensor 1730 is fed into a fully connected (FC) neural network head 1732. The FC head 1732 performs two fully connected layers to produce class score and bounding box predictor delta tensor 1734. The class score is generally an 80-element tensor, each element corresponding to a prediction score for the corresponding object category. The bounding box prediction deltas tensor is an 80×4=320 element tensor, containing bounding boxes for the corresponding object categories. Final processing is performed by an output layers module 1736, receiving the tensor 1734 and performing a filtering operation to produce a filtered tensor 1738. Low-scoring (low classification) objects are removed from further consideration. A non-maximum suppression module 1740 receives the filtered tensor 1738 and removes overlapping bounding boxes by removing the overlapped box with a lower classification score, resulting in an inference output tensor 1740, corresponding to the tensor 151.

The weights information 1193 may include a ‘no_weights_flag’, indicating that the decoder network topology to be used does not require any weights in order to operate.

In an arrangement of the source device 110 and the destination device 140, network weights are signalled in the bitstream 121 as a delta relative to another set of network weights (the ‘base weights’) that are known to the system 100 or may be obtained via external means, such as from the tensor codec repository 180. The base weights may be indicated via reference using an identifier number stored in the bitstream 121. Signalling of network weights as a delta relative to other network weights may be accomplished using a syntax such as ‘MPEG Incremental Neural Network Representation’, under development as part of ISO/IEC 15938-17.

Although identifiers for decoder network topologies and network weights are shown in Appendix A as unsigned integer values, coded using unsigned exponential Golomb codewords, other representations are possible. For example, decoder network topologies and network weights can be coded using variable-length UTF-8 strings or “Universally Unique Identifier” (UUID) strings or other encodings.

Although metadata written by the metadata encoder 544 and the metadata parser 1208 is described with reference to the SEI message 1113, the metadata may be stored using an SPS extension mechanism and/or a PPS extension mechanism. Metadata that remains fixed for the duration of usage of one decoder network topology, such as the packing information 1194, the decoder topology 1192 and the complexity indication 1191 may be stored in the SPS. Metadata that may vary during execution of one decoder network topology, such as quantisation ranges 1196 and tensor information 1195 (e.g., channel count) may be stored in the PPS. Extension mechanisms for the SPS and PPS enable definition of additional syntax to signal additional parameters beyond those specified in a given version of the VVC (or HEVC) standard.

Methods presented herein enable efficient representation of tensors in a format being amenable to compression using contemporary block-based compression standards such as VVC or HEVC. Block-based compression, although not intuitively applicable to data such as compressed feature maps or coefficients for projecting basis vectors to reconstruct feature maps, uncover additional unexpected redundancy in blocks such as by use of various transforms including trained secondary transforms. Although methods presented herein are described with reference to the ‘Faster RCNN’ and ‘YOLOv3’ network architectures and specific divisions of these networks into ‘backbone’ and ‘head’ portions, the methods are applicable to any neural network operating on multi-dimensional tensor data and are applicable to different divisions of such networks into ‘backbone’ and ‘head’ portions.

It should be noted that although the source device 110 and the destination device 140 are described with reference to the video source 112 comprising video and image data, other types of content such as audio data or textual data may also be supplied as input to neural networks applicable to such types of input and the resulting intermediate feature maps may be compressed and decompressed by the modules 116 and 146 with suitable encoder and decoder network topologies.

### INDUSTRIAL APPLICABILITY

The arrangements described are applicable to the computer and data processing industries and particularly for the digital signal processing for the encoding and decoding of signals such as video and image signals, achieving high compression efficiency.

The foregoing describes only some embodiments of the present invention, and modifications and/or changes can be made thereto without departing from the scope and spirit of the invention, the embodiments being illustrative and not restrictive.

### APPENDIX A

An example SEI message format and associated semantics for representing metadata associated with tensor decompressor structure, tensor packing, and complexity indication in a bitstream are as follows:

| | Descriptor |
|---|---|
| fcvcm_decoder_info( payloadSize ) { | |
| set_level_flag | u(1) |
| if( set_level_flag ) | |
| fcvcm_level | u(8) |
| update_decoder_flag | u(1) |
| if( update_decoder_flag = = 1 ) { | |
| no_weights_flag | u(1) |
| explicit_signal_decoder_flag | u(1) |
| if( explicit_signal_decoder_flag ) { | |
| explicit_decoder_compression_idc | u(2) |
| explicit_decoder_format_idc | u(4) |
| explicit_decoder_format_version_idc | ue(v) |
| explicit_decoder_payload_len | ue(v) |
| for( i = 0; i < explicit_decoder_payload_len; i ++ ) | |
| decoder_payload[ i ] | u(8) |
| register_decoder_idc_flag | u(1) |
| if( register_decoder_idc_flag ) | |
| decoder_idc | ue(v) |
| } else { | |
| registered_decoder_idc | ue(v) |
| } | |
| } | |
| if( !no_weights_flag ) { | |
| update_weights_flag | u(1) |
| if( update_weights_flag ) { | |
| explicit_signal_weights_flag | u(1) |
| if( explicit_signal_weights_flag ) { | |
| explicit_weights_idc | ue(v) |
| explicit_weights_payload_len | ue(v) |
| for( i = 0; i < explicit_weights_payload_len; i++ ) | |
| weights_payload[ i ] | u(8) |
| } | |
| } | |
| } | |
| set_region_cnt_flag | u(1) |
| if( set_region_cnt_flag ) | |
| region_cnt | ue(v) |
| set_region_packing_flag | u(1) |
| if( set_region_packing_flag ) { | |
| for( i = 0; i < region_cnt; i++ ) { | |
| top_left_rsctuaddr[ i ] | u(v) |
| top_right_rsctuaddr[ i ] | u(v) |
| bottom_left_rsctuaddr[ i ] | u(v) |
| bottom_right_rsctuaddr[ i ] | u(v) |
| horizontal_packing_flag[ i ] | u(1) |
| } | |
| } | |
| set_tensor_info_flag | u(1) |
| if( set_tensor_info_flag ) | |
| for( i = 0; i < region_cnt; i++ ) { | |
| region_tensor_cnt[ i ] | ue(v) |
| for( j = 0; j < region_tensor_cnt[ i ]; j++ ) { | |
| tensor_max_channels[ i ][ j ] | ue(v) |
| tensor_width[ i ] [ j ] | ue(v) |
| tensor_height[ i ] [ j ] | ue(v) |
| } | |
| } | |
| } | |
| update_tensor_channels_flag | u(1) |
| if( update_tensor_channels_flag ) | |
| for( i = 0; i < region_cnt; i++ ) | |
| for( j = 0; j < region_tensor_cnt[ i ] ) { | |
| update_tensor_channel_flag[ i ][ j ] | u(1) |
| if( update_tensor_channel_flag ) | |
| tensor_channel_cnt | ue(v) |
| } | |
| } | |

Where u(n) refers to a fixed-length codeword n bits in length and ue(v) refers to an unsigned exponential Golomb variable-length codeword.

### FCVCM Decoder Info Semantics:

set_level_flag equal to one indicates that the tensor decompression complexity indication is to be signalled in this instance of the FCVcM decoder info SEI message.

fcvcm_level signals the complexity indication for any tensor decompressors to be performed in the decoder. The complexity indication provides a worst-case limit on the complexity of any instantiated tensor decompressor. It is a requirement of bitstream conformance that the tensor decompression complexity indication is signalled prior to use of the FCVCM decoder, e.g., signalled with the first frame of packed tensor data in the bitstream. The following table shows permitted maximum values for complexity aspects for given fcvcm_level values:

| fcvcm_level | MAC count | Weight count |
|---|---|---|
| 0 | <5M | <1M |
| 1 | <15M | <5M |
| 2 | <50M | <10M |
| 3-254 | (reserved for future use) | (reserved for future use) |
| 255 | | |

update_decoder_flag equal to one indicates that the FCVCM decoder is to be updated, effective from this instance of the FCMVCM decoder info SEI message onwards.

no_weights_flag equal to one indicates that the FCVCM decoder does not include any trained elements (e.g., convolutions) and therefore does not require any weights.

explicit_signal_decoder_flag equal to one indicates that the FCVCM decoder architecture is signalled explicitly in this instance of the FCVCM decoder info SEI message. When equal to zero, this instance of the FCVCM decoder info SEI message instead references a previously signalled FCVCM decoder architecture or references an FCVCM decoder architecture obtained by external means, e.g., a predetermined architecture or an architecture available from a publicly accessible registry.

explicit_decoder_compression_idc specifies the compression technique (if any) applied to the payload containing the representation of the FCVCM decoder architecture, in accordance with the following table:

| explicit_decoder_compression_idc | Compression method |
|---|---|
| 0 | None |
| 1 | DEFLATE |
| 2 | LZMA |
| 3 | Reserved for future use |

explicit_decoder_format_idc specifies the format in which the FCVCM decoder architecture is encoded, with the following formats supported:

| explicit_decoder_format_idc | Decoder representation format |
|---|---|
| 0 | ONNX |
| 1 | NNEX |
| 2 | Pytorch |
| 3 | Variable-length scheme |
| 4-15 | Reserved for future use |

explicit_decoder_format_version_idc specifies the version of the format in which the FCVCM decoder architecture is encoded. For each supported format, a separate enumeration of explicit_decoder_format_version_idc values to versions Of the format is specified.

explicit_decoder_payload_len specifies the length of the payload containing the FCVCM decoder representation in bytes, after application of Compression (if applicable).

decoder_payload[i] specifies the ith byte of the FCVCM decoder representation.

register_decoder_idc_flag equal to one indicates that the FCVCM decoder representation signalled in this instance of the FCVCM decoder info SEI message is to be registered (retained) in the decoder for potential future reference.

decoder_idc specifies an index value for addressing the FCVCM decoder representation in a registry of retained FCVCM decoder architectures.

explicit_signal_weights_flag equal to one indicates that weights associated with the signalled FCVCM decoder representation are included in this instance of the FCvCM decoder info SEI message.

explicit_weights_idc specifies an index for the weights signalled in this instance of the FCvCM decoder info SEI message.

explicit_weights_payload_len specifies the length of the weights payload in the FCvCM decoder info SEI message.

weights_payload[i] specifies the ith byte of the weights payload in the FcVCM decoder info SEI Message.

register_weights_idc_flag equal to one specifies that the weights signalled in this instance of the FCVCM decoder info SEI message are stored in the FCVCM decoder for potential future reference.

registered_decoder_idc specifies an index to address an FCVCM decoder representation that is either known to the decoder by external means or was registered with the FCVCM decoder in an earlier instance of the FcVCM decoder info SEI Message.

set_region_cnt_flag equal to one indicates that this instance of the FCVCM decoder info SEI message signals a count of regions into which the current and subsequent pictures are to be Divided.

region_cnt indicates a count of regions into which the current and subsequent pictures are to be divided. Each region is rectangular in shape and aligned to CTU boundaries. Each region is populated with feature Maps from one or more Tensors.

set_region_packing_flag equal to one indicates that this instance of the FCVCM decoder info SEI message specifies a division of the current picture into one or more rectangular regions.

This division remains in effect until the next instance of an FCVCM decoder info SEI message with set_region_packing_flag equal to one.

top_left_rsctuaddr[i] specifies the address in raster-scan order of the CTU in the top-left position in the ith region.

top_right_rsctuaddr[i] specifies the address in raster-scan order of the CTU in the top-right position in the ith region.

bottom_left_rsctuaddr[i] specifies the address in raster-scan order of the CTU in the bottom-left position in the ith region.

bottom_right_rsctuaddr[i] specifies the address in raster-scan order of the CTU in the bottom-right position in the ith region.

horizontal_packing_flag[i] equal to one specifies when the packing or unpacking progresses from one feature maps of one tensor to feature maps of the next tensor within the ith region, packing will continue long in a left-to-right manner. When equal to zero, upon progressing from feature maps of one tensor to feature maps of the next tensor, packing of feature maps advances to the leftmost position in the current region and below the previously packed feature maps within the current region. The value one may be used where multiple tensors, each containing few (e.g., one) feature maps are to be packed, requiring a region generally larger in width than in height and generally Smaller frame area for The regions.

set_tensor_info_flag equal to one specifies that the number of tensors in the defined regions and dimensions of these tensors is signalled in this instance of The FCVCM decoder info SEI message.

region_tensor_cnt[i] specifies the number of tensors to be packed in the ith region.

tensor_max_channels[i][j] specifies the maximum number of feature maps (i.e., channels) of the jth tensor being packed in the ith region.

tensor_width[i][j] specifies the width of feature maps of the jth Tensor being packed in the ith region.

tensor_height[i][j] specifies the height of feature maps of the jth tensor being packed in The ith region.

update_tensor_channels_flag equal to one indicates that the flags to update packed number of feature maps for each tensor in each region are to be signalled in this instance of the FCVCM decoder info SEI message.

update_tensor_channel_flag[i][j] equal to one indicates that the packed number of feature maps for the jth tensor in the ith region is to be signalled in this instance of the FCVCM decoder info SEI message.

tensor_channel_cnt[i][j] specifies the packed number of feature maps (i.e., channels) for the jth tensor of the ith region. When tensor_channel_cnt[i][j] is not signalled and tensor_max_channels[i][j] is signalled, the value is inferred to be equal to the corresponding tensor_max_channels[i][j]. When tensor_channel_cnt[i][j] is not signalled or inferred in the current instance of the FCVCM decoder info SEI message, the value remains in effect from the previous instance of the FCVCM decoder SEI message (if available), otherwise the value is inferred as 0.

### APPENDIX B

The following code fragment shows a Python definition of the MSFC-based decoder network topology 1500, capable of decompressing one tensor to produce four decoded tensors.

```
class Decompressor( ):
  def _{——}init_{——}(self):
      super(Decompressor, self)._{——}init_{——}( )
      self._input_channels_se = None
      self._squeeze_channels = None
      # Set independent parameters
      self._set_params( )
      # Derive dependent parameters (if not already explicitly
set)
      if not self._input_channels_se:
        self._input_channels_se = [self._layers *
self._channels_per_layer] * self._se_instances
      if not self._squeeze_channels:
        self._squeeze_channels = [ic // self._ratio for ic
in self._input_channels_se]
      # Instantiate model based on all parameters
      self._instantiate( )
  def _set_params(self):
      self._channels_per_layer = 256
      self._se_instances = 1 # Number of Squeeze/excite
instances in MSFF
      self._ssfc_instances = 1 # Number of SSFCs
      self._layers = 4 # layers per SSFC instance
      self._ratio = 16
      self._F_channels = 256
      # Number of channels after encoded (C′) = 64, same as
m59576;
      # number of channels = [8, 16, 32, 64] in MSFC - Zhicong
Zhang
      self._C_prime_channels = 64 # SSFC further reduction
      self._suppress_tanh = False # For experiment
    def _instantiate(self):
      “““
      Instantiate single or dual MSFC pytorch modules
      ”””
      se_pool = nn.AdaptiveAvgPool2d((1,1)) #1x1xC
      self.add_module(‘se_pool’, se_pool)
      se_fc0 = nn.Linear(self._input_channels_se[i],
self._squeeze_channels[i])
      self.add_module(‘se_fc0’, se_fc0)
      se_fc1 = nn.Linear(self._squeeze_channels[i],
self._input_channels_se[i])
      self.add_module(‘se_fc1’, se_fc1)
      se_act0 = torch.nn.modules.activation.ReLU( )
      self.add_module(‘se_act0’, se_act0)
      se_act1 = nn.Tanh( )
      self.add_module(‘se_actl’, se_act1)
      # Final conv in MSFF not part of SE block but one needed
per SE block
      msff_conv0 = torch.nn.Conv2d(self._input_channels_se[i],
self._F_channels, 3, stride=1, padding=‘same’)
      self.add_module(‘msff_conv0’, msff_conv0)
      ssfc_enc_conv0 = torch.nn.Conv2d(self._F_channels,
self._C_prime_channels, 3, stride=1, padding=‘same’)
      self.add_module(‘ssfc_enc_conv0’, ssfc_enc_conv0)
      ssfc_enc_bn0 = nn.BatchNorm2d(self._C_prime_channels)
      self.add_module(‘ssfc_enc_bn0’, ssfc_enc_bn0)
      if not self._suppress_tanh:
        ssfc_enc_act0 = nn.Tanh( )
        self.add_module(‘ssfc_enc_act0’, ssfc_enc_act0)
      ssfc_dec_conv0 = torch.nn.Conv2d(self.C_prime_channels,
self._F_channels, 3, stride=1, padding=‘same’)
      self.add_module(‘ssfc_dec_conv0’, ssfc_dec_conv0)
      ssfc_dec_bn0 = nn.BatchNorm2d(self._F_channels)
      self.add_module(‘ssfc_dec_bn0’, ssfc_dec_bn0)
      ssfc_dec_prelu0 = nn.PRELU( )
      self.add_module(‘ssfc_dec_prelu0’, ssfc_dec_prelu0)
      C = self._channels_per_layer
      msfr_conv0 = torch.nn.Conv2d(C, C, 3, stride=1,
padding=‘same’)
      self.add_module(‘msfr_conv0’, msfr_conv0)
      msfr_conv1 = torch.nn.Conv2d(C, C, 3, stride=1,
padding=‘same’)
      self.add_module(‘msfr_conv1’, msfr_conv1)
      msfr_conv2 = torch.nn.Conv2d(C, C, 3, stride=1,
padding=‘same’)
      self.add_module(‘msfr_conv2’, msfr_conv2)
      msfr_upsampling8 =
nn.UpsamplingNearest2d(scale_factor=8)
      self.add_module(‘msfr_upsampling8’, msfr_upsampling8)
      msfr_upsampling4 =
nn.UpsamplingNearest2d(scale_factor=4)
      self.add_module(‘msfr_upsampling4’, msfr_upsampling4)
      msfr_upsampling2 =
nn.UpsamplingNearest2d(scale_factor=2)
      self.add_module(‘msfr_upsampling2’, msfr_upsampling2)
  def _squeeze_excite_block(self, tensor, ):
      se_pool = getattr(self, ‘se_pool’)
      se = se_pool(tensor)
      #transpose se
      se = se.permute(0, 2, 3, 1)
      se_fc0 = getattr(self, ‘se_fc0’)
      se1 = se_fc0(se)
      activation = getattr(self, ‘se_act0’) #
torch.nn.modules.activation.ReLU( ) #1x1xC/r
      se2 = activation(se1)
      se_fc1 = getattr(self, ‘se fc1’)
      se3 = se_fc1(se2) #1x1xC
      activation2 = getattr(self, ‘se_act1’) # nn.Tanh( )
      se4 = activation2(se3) #1x1xC
      se4 = se4.permute(0, 3, 1, 2)
      se5 = se4.expand(torch.Tensor.size(tensor)) #scale -->
HxWxC
      x = se4 + tensor
      return x
  def _ssfc_decode(self, tensor):
      # Single-scale feature compression decoder
      #assert torch.Tensor.size(tensor)[1] ==
self._C_prime_channels
      ssfc_dec_conv0 = getattr(self, ‘ssfc_dec_conv0’)
      x = ssfc_dec_conv0(tensor)
      batch_norm = getattr(self, ‘ssfc_dec_bn0’ ) #
nn.BatchNorm2d(self._F_channels)
      x = batch_norm(x)
      activation = getattr(self, ‘ssfc_dec_prelu0’) #
nn.PRELU( ) #or softmax
      x = activation (x)
      return x
  def _msfr(self, P_decode):
      # multi-scale feature reconstruction (MSFR) module
      P2_decode = self.msfr_upsampling8(P_decode)
      P3_1 = torch.nn.functional.interpolate(P2_decode,
scale_factor=[1/2,1/2])
      P3_2_up = self.msfr_upsampling4(P_decode)
      P3_decode = self.msfr_conv0(P3_1) + P3_2_up
      P4_1 = torch.nn.functional.interpolate(P3_decode,
scale_factor=[1/2,1/2])
      P4_2_up = self.msfr_upsampling2(P_decode)
      P4_decode = self.msfr_conv1(P4_1) + P4_2_up
      P5_1 = torch.nn.functional.interpolate(P4_decode,
scale_factor=[1/2,1/2])
      P5_decode = self.msfr_conv2(P5_1) + P_decode
      pooling_MSFR = nn.MaxPool2d(3, stride=2, padding=1)
#nn.AdaptiveAvgPool2d((P6_size2, P6_size3))
      P6_decode = pooling_MSFR(P5_decode)
      return {
        ‘p2’ : P2_decode,
        ‘p3’ : P3_decode,
        ‘p4’ : P4_decode,
        ‘p5’ : P5_decode,
        ‘p6’ : P6_decode
      }
  def decompress(self, compressed):
      # single-stream feature codec (SSFC) stride = 32 in
“MSFC − IEEE”
      F_dec = [self.ssfc_decode(compressed)
      # MSFR
      msfr_output = self._msfr(F_dec)
      return msfr_output
```

### Complexity Indication Example:

### 1. Tensor Information

| Region, tensor | Dimensions | Argument |
|---|---|---|
| 0, 0 | [32, 19, 34] | compressed |

### 1. Computational Complexity Calculation

The operation count can be derived by running the provided code fragment using a pseudo-execution mode where instead of performing operations such as convolution, max pooling, replacement implementations of these functions that merely count the MACs required for each operation are performed based on provided input tensor dimensionality, returning zero-valued tensors of appropriate size for later use.

### 2. Weight Complexity Calculation

Based on the parameters supplied to trainable elements the weight memory requirements can be computed. For example, the number of weights for a convolution depends on the kernel size and the channels in and channels out parameters.

### 3. Persistent Storage Calculation

Variables declared and assigned to the ‘self’ object, e.g., in the_init_method, may contribute to the persistent storage memory calculation.

### APPENDIX C

The following code fragment shows a Python (using numerical library ‘numpy’ only) definition of the PCA-based decoder network topology 1400, capable of decompressing one tensor to produce one decoded tensor. The code fragment is assumed to implement a ‘decompress’ method as part of a ‘Decompressor’ class that accepts three arguments, each containing one or more tensors unpacked from the three pictures 910, 912, and 916, respectively. The input arguments to the ‘decompress’ method a reference to a persistent state object ‘self’ followed by the compressed tensors 1224 and the tensors returned from the ‘decompress’ method are the tensors 149. Each input argument and the return value of the ‘decompress’ method may be one tensor in the form of a ‘numpy’ array or a list of tensors.

```
class Decompressor( ):
  def decompress(self, mean, basis_vectors, coefs):
    channels = mean.shape[0]
    n_components = basis_vectors.shape[−2]
    height, width = coefs.shape[−2:]
    area = height * width
    coefs1 = np.reshape(coefs, [n_components, area])
    mean = np.reshape(mean, [1, channels])
    decompressed = np.zeros([1, channels, height, width],
dtype=np.float32)
    inv_transformed = np.dot(coefs1.T, basis_vectors)
    inv_transformed += mean
    for idx in range(channels):
      flattened = inv_transformed[:, idx]
      decompressed[0, idx, :, : ] = np.reshape(flattened, [height,
width])
    return decompressed
```

### Complexity Indication Example:

### 4. Tensor Information

| Region, tensor | Dimensions | Argument |
|---|---|---|
| 0, 0 | [256, 1] | mean |
| 1, 0 | [25, 256] | basis_vectors |
| 2, 0 | [25, 76, 136] | coefs |

Each region contains one tensor, having dimensions as indicated and usage as indicated.

These input tensors result in the following internal variables:

channels=256, n_components=25, weight=136, height=76, area=10336.

### 5. Computational Complexity Calculation

Computational complexity of operations like ‘reshaping’ a tensor (rearranging the dimensionality) is ignored, as are standalone multiplications (i.e., not operating on arrays) and assignments (including accessing a portion or ‘slicing’ of an array) and transpose operations (e.g., the ‘coefs1.T’ operation).

Memory bandwidth complexity estimation may include the costs of variable assignments, including those resulting from slicing of arrays.

Operation ‘np.dot’ performs a dot product on inputs of dimensions [10336, 25] and [256, 25], resulting in 25×256×10336=66,150,400 MAC operations.

### 6. Weight Complexity Calculation

This code fragment uses no Pytorch trained operations such as convolutions and hence uses no weights.

### 7. Persistent Storage Calculation

This code fragment makes no reference to the ‘self’ object and hence retains no information from one invocation to the next invocation.

1. A method of decoding tensors for content of a bitstream, the method comprising:
determining a network topology from the bitstream;
decoding a first information from the bitstream; and
producing decoded tensors from the first information using the determined network topology.

2. The method according to claim 1, wherein the network topology is determined by decoding second information representing a network topology from the bitstream.

3. The method according to claim 1, wherein the first information includes one or more tensors and/or one or more coefficients.

4. The method according to claim 1, wherein at least part of the first information is stored in a packed frame of video data.

5. The method according to claim 1, wherein the decoded tensors are produced by instantiating a decoder network based on the determined network topology and executing the decoder network.

6. The method according to claim 1, wherein the decoded tensors are produced by executing a decoder network based on the determined network topology.

7. The method according to claim 1, wherein the second information representing the network topology is signalled in a supplementary enhancement information (SEI) message.

8. The method according to claim 1, wherein the second information representing the network topology is signalled in compressed-form, using a syntax.

9. The method according to claim 1, wherein the decoded network topology is retained for future reference even after a different network topology is used.

10. The method according to claim 1, wherein the network topology is indicated using an identifier.

11. The method according to claim 1, wherein the network weights are signalled in a supplementary enhancement information (SEI) message.

12. The method according to claim 1, wherein the network weights are indicated using an identifier.

13. The method according to claim 1, wherein the content is one or more of audio data, video data, image data, and textual data.

14. A decoder for decoding tensors for content of a bitstream, the decoder configured to:
determine a network topology from the bitstream;
decode a first information from the bitstream; and
produce decoded tensors from the first information using the determined network topology.

15. A non-transitory computer-readable medium which stores a program for executing a method of decoding tensors for content of a bitstream, the method comprising:
determining a network topology from the bitstream;
decoding a first information from the bitstream; and
producing decoded tensors from the first information using the determined network topology.

16. A system comprising:
a memory; and
a processor, wherein the processor is configured to execute code stored on the memory for implementing a method of decoding tensors for content of a bitstream, the method comprising:
determining a network topology from the bitstream;
decoding a first information from the bitstream; and
producing decoded tensors from the first information using the determined network topology.
